(19) United States
(12) Patent Application Publication
(10) Pub. No.: US 2021/0019339 A1
(43) Pub. Date: Jan. 21, 2021

(54) MACHINE LEARNING CLASSIFIER FOR CONTENT ANALYSIS

(71) Applicant: Factmata Limited, London (GB)

(72) Inventors: Dhruv GHULATI, London (GB); Rishabh SHUKLA, London (GB); Zeerak WASEEM, London (GB)

(21) Appl. No.: 15/733,603

(22) PCT Filed: Mar. 12, 2019
(86) PCT No.: PCT/GB2019/050693

§ 371 Date: Sep. 11, 2020

Related U.S. Application Data
(60) Provisional application No. 62/654,699, filed on Apr. 9, 2018.
(60) Provisional application No. 62/654,700, filed on Apr. 9, 2018.
(60) Provisional application No. 62/654,900, filed on Apr. 9, 2018.
(60) Provisional application No. 62/654,908, filed on Apr. 9, 2018.
(60) Provisional application No. 62/654,947, filed on Apr. 9, 2018.
(60) Provisional application No. 62/654,968, filed on Apr. 9, 2018.
(60) Provisional application No. 62/655,053, filed on Apr. 9, 2018.

(30) Foreign Application Priority Data
Mar. 12, 2018 (GB) 1803954.5
Mar. 16, 2018 (GB) 1804295.2
Mar. 16, 2018 (GB) 1804297.8
Mar. 21, 2018 (GB) 1804528.6
Mar. 21, 2018 (GB) 1804529.4
Mar. 21, 2018 (GB) 1804532.8
Mar. 26, 2018 (GB) 1804828.0

(51) Int. Cl. G06F 16/332; G06F 40/226; G06F 40/30; G06K 9/62; G06N 20/00; H04L 29/08

(52) U.S. Cl. CPC G06F 16/3329; G06F 40/226; H04L 67/146; G06K 9/6256; G06N 20/00; G06F 40/30

(57) ABSTRACT

The present invention relates to a series of methods and systems in respect of online media content. More specifically, the present invention relates to aspects of fact checking of online media content.

### FIELD

Hate Speech

The present invention relates to detection of contentious content for online media. Specifically, the present invention relates to the detection of contentious content such as hate speech.

Hyperpartisanship

The present invention relates to determining bias in content. More particularly, the present invention relates to determining bias scores for one or more pieces of content based on metadata and related material available in relation to the content.

Author Credibility Score

The present invention relates to a method of determining credibility scores for users based on extrinsic signals. More particularly, the present invention relates to a method of determining a credibility score for users based on user metadata and content generated by the users.

Explainability

The present invention relates to a method of storing data in relation to annotations. More particularly, the present invention relates to a method of storing data in relation to one or more annotations for enabling the visualisation and/or adjusting of the data.

Bias Detection

The present invention relates to a method for determining a stance score in relation to content. More particularly, the present invention relates to a method of determining one or more scored indicative of stance in relation to content based on entity identification.

Annotation Platform

The present invention relates to a method of determining content scores. More particularly, the present invention relates to a method of determining one or more content scores for a piece of content based on one or more inputs and metadata.

Q-CPM

The present invention relates to a method of determining a cost of advertising on content. More particularly, the present invention relates to a method of determining a cost of advertising on content based on metadata and content quality.

### BACKGROUND

Hate Speech

Contentious content detection systems, and hate speech detection systems in particular, focus on detecting language in online media content that can be hurtful, abusive, or incite hate towards a particular civil group or section of society. This may include: sexist, racist or ethnic slurs; content targeting a minority; content which seek to negatively distort views on a marginalized group; negatively stereotyping content; and content which shows to defend xenophobia. The technology of these detection systems has been mandated across countries and blocs such as the European Union as being damaging to the functioning of democracy, and the healthy discourse on the internet.

Online social platforms are beset with contentious content. Such content may frighten, intimidate, or silence users within these communities. In some case, such content may wrongly inspire users to share content, generate similar content, or even commit violence. The widespread problems brought about by online contentious content are widely recognised in society and despite the knowledge of the impacts such content have, reliable solutions are lacking and effective methods and systems have not been achieved.

Methods of detecting the presence of hateful or abusive language within text coming from online media sources contain annotation processes. However, annotation processes for hate speech currently can have a negative psychological impact during the course of annotation and moderation including post-traumatic stress disorder in recent times. Current systems are expensive to implement and often require the training of keyword systems which do not perform to a high standard across several established platforms. It is acknowledged that keyword-based methods and systems are insufficient for the detection of contentious content such as hate speech and substantial improvements over current approaches must be made.

Currently, models that are being and have been built can typically deal with content within a single category/domain i.e. hate speech/cyberbullying/toxicity etc. However, such approaches have not yet been capable of managing to find and leverage the commonalities between these distinct domains. Further, training models on specific types of underlying forms within each domain, for example racism and sexism within hate speech, also perform poorly when implemented for other domains of contentious content. An aspect of this invention will address the issues of leveraging commonalities between distinct domains of contentious content within online communities and platforms.

Hyperpartisanship

There is no completely clear answer in determining whether sources are left-leaning, centrist, or right-leaning as there is no exact methodology to measure and rate the partisan bias of sources. Current methods are survey based, asking people on a wide spectrum of known political backgrounds where they get their information (news) from, and what they judge to be biased or unbiased.

Various problems are evident with current technology in determining the bias of a content source as described herein. Lack of technological methods which also lack scalability; current methods base bias on the publication source rather than the content such as an article itself; current methods do not account for the bias of the annotator; the narrow range of annotator profiles.

Current methods also lack the capability to determine the bias of content in real time and do not take into account context of the world. As new entities and contents are generated online, surveys cannot be undertaken at the same level of content generation. There is no technological system for scoring the political bias of a certain type of content. The key problems associated with such a system is the difficulty for users of news articles to truly know and understand the bias of the articles they are reading. For example, do they realise that all the statements they make are towards one entity, being against that one entity? Do they realise that effectively the article only shows one point of view?

Use cases for a bias detection system may prove to be greatly beneficial to users, sources as well as brands. Such a system may help users of newsfeeds to be able to filter out content or categorise what is within their news aggregator by news filters, for example displaying only left-bias articles. Editors may detect bias when their writing may not be totally impartial or showcasing projection leaned to one side. The system may also prevent advertisers from advertising on extreme left/right content which may be damaging to their brand.

Author Credibility Score

Current social credit scoring applications, if incorporating user profiles, account for age, gender, other personal metadata, as well as a limited range of online content signals such as use of pornography, what blogs or articles the user reads and so on. In the process of credibility scoring very little is taken into account of what the user generated content of a user actually entails.

The focus of existing technology based on credibility of content are domain specific being implemented on articles, blog posts or tweets for example. However, these technologies are not capable of analysing content on a semantic level or a combination of the different types of content and can only determine a general high-level credibility value or score rather than the credibility of an author or journalist to a specific topic of the content item in question. The credibility analysis of content is currently based on user endorsements such as likes, shares, and clicks lacking in assessing the credibility of the actual text of comments and the credibility of those comments as well as the authors of the comment.

Present scoring systems in assessing the credibility of content categorise the content into categories such as true, mostly true, mostly false or false. There is a lack of insight into the output of such systems and there is a need for more informative outputs of credibility scores for comments such as “I think this is interesting”. Rather than labelling the comment, the ability to imply a quality score, for example 67%, may inform a user regarding the credibility of the content based on the credibility of the comment, and more particularly the author of the comment.

Informative scoring of credibility may allow authors, journalists and online users to be scored disregarding their reputations or their biased ways of appealing to a certain audience. When combined with filtering systems, a new way credibility scoring may encourage the prevention of abuse and toxicity within online platforms. Further example applications may include, determining a user's financial credit score and building an online resume for employers based on online content.

Explainability

Currently algorithms are trained by annotators who are employed to manually label data. However, in such cases, the annotator's backgrounds and inherent biases in assigning subjective judgements to content such as articles are not being accounted for within their annotation scores. The main reason for the inconsideration of such factors is due to the opaque and untraceable data in relation to users used to train models. For example, those who label articles as fake news may have a bias due to their background of a particular political leaning and thus may be more inclined to label one type of news as fake, hence corrupting the annotation process.

Existing solutions to the process of removing bias in algorithms include the following examples: algorithmic auditing; transparency, and in particular qualified transparency; open source code; and reverse reduction. Current methods which seek to moderate online content or classify information embed known biases of input data into an algorithm. For example, automated policing methods may not account for the data used to train the model i.e. crime statistics which are unfair, however show that most criminal court cases are for coloured people.

Tackling the issues around biased annotations may result in optimisation regarding a variety of areas. Example may include effective and efficient content moderation, improving credibility and quality scores for users and user generated content, and assistance with triaging defamation.

Bias Detection

Stance detection systems essentially take user-generated content and understands subjective opinion polarity often outputting labels such as in favour or against. Stance detection studies are for the most part applied to text within online debates wherein the stance of the text owner towards a particular target or entity is explored. There are many applications which benefit from automated stance detection technologies such as summarisation of text and more particularly opinion summarisation as well as textual entailment. Stance detection also plays an important component of determining bias and fake news.

Existing technologies assessing bias within documents are predominantly based on explicit supervised labels indicating that an article is overly “biased” or “unfair” These supervised labels are determined based mainly on supervised learning, and in some cases active learning and semi-supervised learning. There also exist classifiers which classify text as extreme right, right, left, extreme left for example. Although explicit supervised labels give an overview of what may or may not be biased, these technologies are incapable of analysing further into the entity subject to bias within the document. This causes lack of explanation of the supervised labels and the inability to explore the bias in more detail.

In many cases, text may entail explicitly positive or negative views targeting an entity, at the same time inferring entities which are not mentioned within the text. In such cases, current technologies are incapable of building graphical representations of what the article mentions or does not mention, as well as the stance of the article towards multiple entities. Current classifiers for news bias focus on one classification system on whether an entire article is biased or not. This is a limited approach as it does not specify what the article is actually biased for or against including explicitly and implicitly mentioned entities such as people, places or things.

Annotation Platform

Annotations may be represented as an additional layer with respect to a content generated online and may be integrated within the content itself. Web annotation systems comprise online annotation platforms which may be associated with a web resource. Within such system, annotation platform users may be provided with the ability to add, modify, highlight or tag information without the modification of the resource itself. The annotations built up on a certain platform may be visible to users of the same annotation system which are presented through an extension tool or part of a web browser.

Annotation platforms may be used for a variety of purposes including: in order to rate online content via a scoring scale; in order to make annotations to a piece of content visible to users of an online platform; and as a collaboration tool for example for students and researchers to store notes and links regarding a specific topic. Existing annotation platforms however only present manual annotations purely as they are annotated on a page. They do not consider annotation tools as a method of gathering supervised or semi-supervised training data for a content scoring system, or as a method of active learning where annotators help to fill in blanks for classifications where an algorithm may show uncertainty. Moreover, existing systems store basic information about annotator's identities such as usernames and past annotations. These systems do not consider the display and storage of user metadata or content metadata which may cause incorrect or biased annotations regarding the content in question.

Existing annotation platforms are mainly based on persisting comments on a HTML page structure of a specific paragraph or sentence, rather than quickly tagging and commenting on such paragraph or sentence (such as user-friendliness or suitability for minors) and sharing externally onto the page; In automating the annotation process to a certain degree, annotations built upon content can be presented fairly through weighting of user annotations with respect to each other and the content on which the annotation is made. Annotation platforms may serve to increase user engagement on content, mitigate incorrect or biased content production, and to provide an informative overview of various aspects in relation to the content. Such systems are required for a variety of applications, for example the policing of online content.

Q-CPM

Programmatic advertising and real-time bidding have changed the face of digital advertising. The means of advertising inventory through buying and selling based on impressions via a programmatic auction involves a demand side platform, supply side platform, ad exchange as well as vast data. Demand side platforms enable advertisers to purchase impressions from a wide spectrum of publisher sites and content which target specific users of content predominantly based on demographics, locations, past and present browsing behaviours, current actions and previous activities. Advertisers may purchase at a higher price in order to target users who may find their content more relevant based on the user data. Current supply side platforms enable content publishers and site owners to provide digital space for advertisements to be placed. Publishers and site owners are connected to a wide range of potential buyers by means of an ad exchange wherein publishers and site owners are able to manage inventory and revenue in order to achieve the highest cost or CPM for the advertisements. Existing technology allow supply side platform users to set a floor price i.e. a minimum price a publisher may accept on a given metric, establish deals and define criteria for advertisements.

One of the great problems within current programmatic advertising technologies lies within the most important aspect of the technology, the method of determining target users and connecting demand side and supply side platform users in order to increase content user engagement, cost effectiveness and increase brand safety. As current technology only relies on demographics, locations, past and present browsing behaviours, current actions and previous activities, there are restriction around targeting content users at a more detailed level of understanding. For example, a certain brand may not wish to place an advertisement alongside a particular article due to the political bias or contentious content present within the article. On the other hand, publishers and site owners of online content may force upon floor prices which are unrepresentative of produced content and may lead to CPM which are not based not the quality of the content generated.

Additional existing issues include: the lack of incentive in creating good quality content; fair competition between popular and unknown publishers of content; and lack of brand safety which may impact user engagement. Brands may be prepared to bid higher prices in order to appear next to good quality content or content which seeks an objective which plays part of a brands mission. Knowing the quality of brands will be incentivised to advertise good quality content.

### SUMMARY OF INVENTION

Hate Speech

Aspects and/or embodiments seek to provide a method for training and detecting contentious content online.

According to the first aspect, there is provided a method for training a machine learning classifier to detect contentious content, the method comprising the steps of: receiving content as input data; receiving annotation data for said content; receiving metadata in relation to said annotation data; and determining a learned approach to classifying whether the content is contentious based on said annotation data for said content and said metadata in relation to said annotation data.

A learning classifier detecting contentious content may allow policing of content in order to create a safer online environment and increase user engagement in the process.

Optionally, there is provided the method further comprising the steps of: receiving further content as input data; determining a classification whether the further content is contentious using the machine learning classifier; and further determining the learned approach to classifying whether the content is contentious based on the further content, wherein the step of determining a classification whether the further content is contentious using the machine learning classifier determines that said further content is contentious content with a high degree of certainty.

Optionally, there is provided the method further comprising the steps of: receiving additional content as input data; determining a classification whether the additional content is contentious using the machine learning classifier; and transmitting the additional content to a reviewing module for classification, wherein the step of determining a classification whether the additional content is contentious using the machine learning classifier determines that said further content is contentious content with a low degree of certainty.

Optionally, the content comprises of content generated online.

Optionally, there is provided the method further comprising any or all of the steps of: reviewing the source of the content; reviewing the relationship between the source of the content and a user; reviewing the domain from which the content is generated; reviewing the profile and user history of the author of the content; reviewing the profiles and user histories of the users within the community the content was generated; reviewing the relationship between the content and other communities; reviewing dictionaries of slurs; reviewing word embeddings; reviewing for contentious words; reviewing sentiments in relation to the unlabelled content; querying one or more questions in relation to the content; and/or examining linguistic cues within the content as part of a natural language processing (NLP) computational stage.

Optionally, a score is determined for said content: optionally wherein determining a score comprises determining a similarity score and/or a probability score and/or threshold score, and/or optionally wherein the similarity score determines an output of the predicted abusive qualities of the content.

The score may serve as an indicator of the level of contentiousness within content.

Optionally, the contentious content comprises any one or more of: hate speech; cyber-bullying; cyber-threats; online harassment; online abuse; sexism; racism; ethnic slur; attack on a minority; negative stereotyping of a minority; negatively distorting the views on a marginalised group/minority; defending xenophobia; and/or defending sexism. Optionally, the contentious content is categorised as explicitly/implicitly targeting a generalised other and/or a named entity.

The classifier may be trained to output the type of contentious contents detected in order to provide a clear indication of the contentious content.

Optionally, one or more classifications and/or scores is assigned a weighting. Optionally, there is provided the method wherein the steps are carried out in a hierarchical order.

The weighting of the one or more classifications and/or scores may account for the various factors taken into account as well as the performance of the classifier.

Optionally, the reviewing module allows one or more users to provide annotation data and metadata in relation to said annotation data for the additional content: optionally through a web platform or browser extension.

The reviewing module can simplify the process of the one or more users providing the annotation data.

Optionally, the user creates a reviewer profile comprising one or more of: social fraction classification; political stance; geographic location; qualification details; and/or experiences.

The reviewer profile can add to user metadata in order to mitigate bias in content or annotation and also serves as training data for unlabelled content.

Optionally, the annotation data comprises one or more of: tags; scores; descriptions; and/or labels.

According to a second aspect, there is provided a method of detecting contentious content, the method comprising the steps of: inputting one or more pieces of content; using the classifier of any preceding claim; and determining a classification of whether the one or more pieces of content is contentious content.

Detecting contentious content may allow policing of content in order to create a safer online environment and increase user engagement in the process.

Optionally, the one or more pieces of content comprises of one or more of: unlabelled content; manually labelled content; scored content; and/or URLs. Optionally, the classifier comprises one or more of: a multi-task learning model; a logistic regression model; a joint-learning model; support vector machines; neural networks; decision trees; and/or an ensemble of classifiers. Optionally, the classifier determines commonalities between one or more of: domains; underlying forms of the domains; dimensions; linguistic characteristics; geographic location; political stance.

The classifier may leverage commonalities between distinctive categories in order to detect contentious content within the distinctive categories accurately.

According to another aspect, there is provided an apparatus operable to perform the method of any preceding feature.

According to a further aspect, there is provided a system operable to perform the method of any preceding feature.

According to an additional aspect, there is provided a computer program operable to perform the method and/or apparatus and/or system of any preceding feature.

Hyperpartisanship

Aspects and/or embodiments seek to provide a method of determining a bias score of content.

According to a further aspect, there is provided a method of determining a bias score of one or more pieces of content, the method comprising the steps of: receiving one or more user scores for each of the one or more pieces of content; receiving user metadata in relation to each user providing the one or more user scores; and determining the bias score for the at least one or more pieces of content by applying a pre-determined weighting to the one or more user scores based on the user metadata.

The method of determining a bias score of one or more pieces of content may serve to provide a real time score indicative of bias within content taking into account various factors such as user bias.

Optionally, the one or more pieces of content comprise any or all of: one or more individual sentences; one or more paragraphs; and/or one or more articles.

The one or more pieces of content comprising any or all of: one or more individual sentences; one or more paragraphs; and/or one or more articles, may contribute to determining a bias score which takes into account a combination of the one or more pieces of content.

Optionally, the one or more user scores is determined using a set of guidelines: optionally wherein the set of guidelines comprise one or more checkpoints; and/or optionally wherein the one or more checkpoints is used to distinguish whether the one or more pieces of content is biased.

The set of guidelines may allow an annotator to fairly and efficiently annotate the content in question.

Optionally, a weighting score is given to each of the one or more user scores.

The weighting score given to each of the one or more user scores can add to determining a neutral representation of the bias score of the one or more pieces of content.

Optionally, the user metadata comprises a reviewer bias for each of the one or more user scores: optionally wherein the reviewer bias is determined by a standard questionnaire; and/or optionally wherein the reviewer bias comprises of a political bias; and/or optionally wherein the weighting score is assigned based on the reviewer bias.

User metadata may contribute to future scores determined by the user and may weigh the user's current and future scores accordingly.

Optionally, the reviewer bias is determined by one or more of: user profiling; community profiling; one or more previous user scores; and/or user activity.

The reviewer bias may contribute to future scores determined by the reviewer and may weigh the reviewer's current and future scores accordingly.

Optionally, the one or more user scores is input using a browser extension.

A browser extension may establish a user-friendly platform for annotation.

Optionally, the step of determining the bias score comprises using and/or updating a neural network and/or a learned approach.

According to another aspect, there is provided an apparatus operable to perform the method of any preceding feature.

According to a further aspect, there is provided a system operable to perform the method of any preceding feature.

According to an additional aspect, there is provided a computer program operable to perform the method and/or apparatus and/or system of any preceding feature.

Author Credibility Score

Aspects and/or embodiments seek to provide a method of determining a score indicative of credibility of one or more users.

According to another aspect, there is provided a method of determining a score indicative of credibility of one or more users, the method comprising the steps of: receiving metadata in relation to each of said one or more users; receiving content generated by said one or more users; determining one or more scores in relation to said content generated by said one or more users; and determining the score indicative of credibility for each of the one or more users based on said one or more scores in relation to said content generated by the one or more users and said metadata in relation to each of said one or more users.

The method of determining a score indicative of credibility of one or more users may result in greater user engagement and serve to increase the level of content quality generated in online platforms thus reducing toxicity.

Optionally, further comprising a step of determining a score indicative of credibility of each piece of content generated by each of the one or more users. Optionally, further comprising a step of determining a score indicative of credibility of all content generated by each of the one or more users.

Credibility scores of contents generated by each of the one or more users can contribute to adjust the credibility scores of users.

Optionally, the metadata in relation to the one or more users comprises any one or more of: gender; age; socio-economic status; socio-economic background; accreditations; financial interests; expertise; verification status; and/or other external user data.

Metadata in relation to the one or more users may further adjust the credibility score of the one or more users

Optionally, the one or more scores comprise one or more automated scores and/or one or more user input scores. Optionally, the one or more automated scores comprise one or more scores indicative of any one or more of: contentious content; content/user bias; content/user quality; content/user credibility; and/or true/false content.

One or more automated scores and/or one or more user input scores may add to the weighting of the score indicative of credibility of the one or more users and may also enable pre-scoring of content prior to comments and endorsements being made.

Optionally, the one or more user input scores is input by highly credible users. Optionally, the step of assessing data reflective of the credibility of the one or more users comprises a step of determining any one or more of: professional affiliations; relationships with other users; interactions with other users; quality of content produced by the one or more users; quality of content associated with the one or more users; credibility of content produced by the one or more users; and/or credibility of content associated with the one or more users.

Determining any one or more of: professional affiliations; relationships with other users; interactions with other users; quality of content produced by the one or more users; quality of content associated with the one or more users; credibility of content produced by the one or more users; and/or credibility of content associated with the one or more users, can impact the credibility of one or more users through acknowledgment.

Optionally, the step of determining a score indicative of the credibility of the content generated by the one or more users further comprises a step of determining one or more genres and/or one or more topics implied in the content: optionally wherein the one or more genres and/or one or more topics implied in the content is compared against one or more genres and/or one or more topics implied in one or more directly related contents.

The step of determining one or more genres and/or one or more topics implied in the content can serve to identify the relevance of the content within a context.

Optionally, the score indicative of the credibility of the content generated by the one or more users is further determined by the combination of the score indicative of the credibility of the content and the score indicative of the credibility of the user.

Optionally, further comprising the step of generating a financial credit score for at least one of the one or more users.

According to a further aspect, there is provided an apparatus operable to perform the method of any preceding feature.

According to an additional aspect, there is provided a system operable to perform the method of any preceding feature.

According to another aspect, there is provided a computer program operable to perform the method and/or apparatus and/or system of any preceding feature.

Explainability

Aspects and/or embodiments seek to provide a method of storing data in relation to one or more annotations for enabling the visualisation and/or adjusting of the data.

According to an additional aspect, there is provided a method of storing data in relation to one or more annotations for enabling the visualisation and/or adjusting of the data, the method comprising the steps of: receiving metadata in relation to the one or more users contributing the one or more annotations and further receiving metadata in relation to content correlating to the one or more annotations; determining a bias score of each of the one or more users contributing the one or more annotations; determining a bias score of the one or more portions of the content; and storing the one or more bias scores such that the scores are associated with the metadata in relation to the one or more users, the content and the one or more annotations.

The method of storing data in relation to one or more annotation may help mitigate corruption within an annotation process.

Optionally, the metadata in relation to the one or more users comprises user profile data and/or information about each user.

Optionally, the data comprises training data, optionally further comprising the step of generating training data from the stored one or more bias scores and said associated metadata in relation to the one or more users and said associated content and said associated one or more annotations.

Generation of training data may be used as input into learned models or algorithms.

Optionally, the data is used by a machine learning process, and optionally wherein the machine learning process comprises a semi-supervised or supervised machine learning process. Optionally, the step of determining a bias score of the one or more portions of the content comprises a step of performing natural language processing tasks. Optionally, the data includes weights, and optionally wherein the weights correlate to the one or more bias scores. Optionally, the weights are determined in accordance to one or more algorithms and/or one or more learned rules, and optionally wherein the weights are determined by logistic regression. Optionally, the weights are determined by one or more users and/or one or more learned models. Optionally, the weights are assigned to each of the one or more annotations and/or each of the one or more users.

The determined weights can contribute to one or more manual or automated scores determined for a user of a user generated content in order to result in a less biased score.

Optionally, further comprising the step of displaying the stored data in relation to the one or more annotations on a user interface. Optionally, the user interface allows one or more users to interrogate a subset of the stored data.

The user interface can be used to visualise the stored data and may also be capable of receiving manual input during interrogation.

According to a further aspect, there is provided an apparatus operable to perform the method of any preceding feature.

According to another aspect, there is provided a system operable to perform the method of any preceding feature.

According to an additional aspect, there is provided a computer program operable to perform the method and/or apparatus and/or system of any preceding feature.

Bias Detection

Aspects and/or embodiments seek to provide a method for determining a score indicative of stance in relation to content.

According to another aspect, there is provided a method for determining one or more scores indicative of stance in relation to content, the method comprising the steps of: identifying the one or more entities mentioned in the content for which the one or more scores indicative of stance can be determined; assessing implied and/or implicit language in the content in relation to each of the one or more entities in order to determine the one or more scores indicative of stance corresponding to each of the one or more entities.

The method for determining one or more score indicative of stance in relation to content can provide a deeper analysis into the bias of content, and more particularly the bias of the user generating the content.

Optionally, further comprising a step of determining one or more entities in correlation to the one or more entities mentioned in the content. Optionally, the step of determining one or more entities in correlation to the one or more entities mentioned in the content comprises a step of determining one or more commonalities between the one or more entities in correlation to the one or more entities mentioned in the content and the one or more entities mentioned in the content.

The step of determining one or more entities in correlation to the one or more entities mentioned in the content can help determine one or more entities which are not mentioned within the content.

Optionally, the one or more entities comprises any one or more of: one or more persons; one or more places; one or more objects; one or more institutions; one or more brands; one or more businesses; one or more countries; and/or one or more organisations. Optionally, the content comprises any content generated online.

Any content generated online may include offline and online content.

Optionally, the step of assessing implied and/or implicit language in the content in relation to each of the one or more entities in order to determine the one or more scores indicative of stance in relation to each of the one or more entities comprises a step of performing natural language processing tasks and/or knowledge graph embeddings. Optionally, the natural language processing tasks comprise any one or more of: entity linking; text understanding; automatic summarization; semantic search; machine translation; name ambiguity; word polysemy; and/or context dependencies. Optionally, further comprising a step of operating one or more learned models. Optionally, the step of operating one or more learned models comprises a step of performing stance detection or one or more methods in conjunction with stance detection: optionally wherein the one or more methods comprises bidirectional conditional encoding.

Operating one or more learned models comprising a step of performing stance detection or one or more methods in conjunction with stance detection may enhance a method and/or system in order to achieve a more accurate and detailed score indicative of stance in relation to content.

Optionally, the one or more entities is input into a user interface. Optionally, the one or more entities input into a user interface is searched within a database: optionally wherein the one or more entities is searched using representational vectors; and/or optionally wherein the one or more entities is searched using knowledge graph embeddings. Optionally, the user interface displays the one or more scores indicative of stance corresponding to each of the one or more entities. Optionally, the one or more scores indicative of stance corresponding to each of the one or more entities input into a user interface is cached and stored into the database.

A user interface can allow user input and provide a score indicative of stance of any searched entity in relation to the content.

Optionally, the one or more scores indicative of stance corresponding to each of the one or more entities contributes to one or more scores indicative of stance in relation to one or more authors of the content. One or more scores indicative of stance in relation to the one or more authors of the content may add as user metadata for future generated content.

According to a further aspect, there is provided an apparatus operable to perform the method of any preceding feature.

According to another aspect, there is provided a system operable to perform the method of any preceding feature.

According to an additional aspect, there is provided a computer program operable to perform the method and/or apparatus and/or system of any preceding feature.

Annotation Platform

Aspects and/or embodiments seek to provide a method of determining one or more content scores for a piece of content.

According to another aspect, there is provided a method of determining one or more content scores for one or more pieces of content, the method comprising the steps of: receiving one or more inputs, each input comprising a content score in relation to the one or more pieces of content; receiving metadata in relation to the one or more inputs and metadata in relation to the one or more pieces of content; and determining one or more content scores indicative of the one or more inputs and the metadata.

The method of determining one or more content scores for a piece of content may decrease the bias in user annotations and create an informative online environment through annotations.

The one or more inputs may comprise labels and/or comments whereby the labels and/or comments can be used as training data for determining a content score. Optionally, the one or more inputs comprise one or more manual inputs and/or one or more automated inputs. Optionally, the one or more manual inputs is provided through a user interface: optionally wherein the user interface is part of an online platform and/or a browser extension.

The user interface may provide a user-friendly environment for annotators to annotate with regards a wide range of categories such as bias and truthfulness of content, directly scoring the credibility or quality of content on a scale, or commenting on how interesting or shocking a piece of content is presented. These annotations can serve as training data for any natural language understanding classifier on paragraphs, sentences or pages.

Optionally, the metadata in relation to the one or more inputs comprise any one or more of: user profile data; user annotation history; and/or one or more automated scores indicative of user bias and/or stance and/or credibility and/or quality. Optionally, the metadata in relation to the one or more pieces of content comprise any one or more of: user profile data; user domain expertise; user potential bias; user content history; one or more automated scores indicative of content bias and/or stance and/or credibility and/or quality; and/or one or more automated scores indicative of user bias and/or stance and/or credibility and/or quality.

Metadata in relation to the one or more inputs may be used to output a content score representative of the annotator population and bias.

Optionally, the one or more inputs comprise any one or more of: one or more tags; one or more labels; one or more comments; and/or one or more scores.

Optionally, the one or more inputs is visible to one or more users.

Tags, labels, comments and/or scores may allow for user-friendly input and may help establish article/text categorisation or content credibility.

Optionally, further comprising a step of categorising the one or more pieces of content: optionally, wherein the one or more pieces of content is categorised using the one or more inputs. Optionally, further comprising a step of determining content credibility: optionally wherein the content credibility is determined using the one or more inputs.

The step of categorising the one or more pieces of content and the step of determining the content credibility may allow for content summarisation, ease of further annotation and be added as training data for models and algorithms.

Optionally, the one or more inputs is stored as training data. Optionally, further comprising a step of determining the one or more content scores for the one or more pieces of content using the training data.

The training data may be used in learning models in order to enhance the annotation process

According to a further aspect, there is provided an apparatus operable to perform the method of any preceding feature.

According to another aspect, there is provided a system operable to perform the method of any preceding feature.

According to an additional aspect, there is provided a computer program operable to perform the method and/or apparatus and/or system of any preceding feature.

Q-CPM

Aspects and/or embodiments seek to provide a method of determining a cost of advertising on content.

According to another aspect, there is provided a method of determining a cost of advertising on content, the method comprising the steps of: receiving metadata in relation to the content and metadata in relation to one or more users; determining a quality score indicative of the quality of the content based on the metadata in relation to the content and metadata in relation to one or more users generating the content.

The method of determining a cost of advertising on content may enhance brand safety, content quality and user engagement within online generated content.

Optionally, the one or more users comprise any one or more of: one or more users generating the online content; one or more advertisers; and/or one or more content users. Optionally, the metadata in relation to the content and the metadata in relation to the one or more users comprises any one or more of: one or more automated scores indicative of content and/or user quality and/or bias and/or credibility; one or more content data; and/or one or more user data.

The metadata in relation to the content and the metadata in relation to the one or more users can be analysed in order to determine the overall quality of the content and the user.

Optionally, the step of determining a quality score indicative of the quality of the content based on the metadata in relation to the content and metadata in relation to one or more users generating the content comprises a step of carrying out natural language processing tasks.

The step of determining a quality score indicative of the quality of the content based on the metadata in relation to the content and metadata in relation to one or more users generating the content comprising a step of carrying out natural language processing tasks can serve to assess content based on inherent natural language and semantics of the content.

Optionally, the step of identifying one or more user data comprises a step of identifying one or more cookie IDs associated with the one or more content users. Optionally, the step of identifying one or more user data further comprises a step of identifying one or more URLs in interaction with the one or more content users.

Optionally, the cost of advertising is based on one or more metrics: optionally wherein the one or more metrics comprises a number of impressions. Optionally, the cost of advertising on the content is pre-determined: optionally wherein the cost of advertising on the content is manually and/or automatically pre-determined.

A pre-determined cost of advertising on the content may determine an appropriate and fair cost of advertising on the content.

Optionally, the step of processing one or more actions taken by the one or more users comprises any one or more of: bidding; selling; and/or buying. Optionally, the cost of advertising on the content is determined in real-time and/or offline.

The step of processing one or more actions taken by the one or more users comprising any one or more of: bidding; selling; and/or buying, may allow for user interaction within selling and bidding platforms.

According to a further aspect, there is provided an apparatus operable to perform the method of any preceding feature.

According to another aspect, there is provided a system operable to perform the method of any preceding feature.

According to an additional aspect, there is provided a computer program operable to perform the method and/or apparatus and/or system of any preceding feature.

### BRIEF DESCRIPTION OF DRAWINGS

Embodiments will now be described, by way of example only and with reference to the accompanying drawings having like-reference numerals, in which:

FIG. 1 shows a general overview of the combined training and implementation of a machine learning classifier;

FIG. 2 shows the process including a triage system in training the machine learning classifier;

FIG. 3 shows a conceptual representation of comparing similarities in content between two communities;

FIG. 4 shows a general overview of the method of determining the bias of content;

FIG. 5 shows a flow diagram of user-user, content-user and content-content relationships;

FIG. 6 shows a flow diagram linking authors, contents and annotations depicting a credibility score for each of the authors, contents and annotations;

FIG. 7 shows tags in relation to a content and comments linked with the content with indication of content and author credibility scores;

FIG. 8 shows examples of reputation function obtained;

FIG. 9 shows an overview of the weighting and re-weighting process;

FIG. 10 shows an index built up using stored data;

FIG. 11 shows an aspect of entity linking in relation to the text within content;

FIG. 12 shows an aspect of stance detection and knowledge graph embeddings within content;

FIG. 13 shows an overview of an annotation platform process; and

FIG. 14 shows an overview of the real-time bidding process.

### SPECIFIC DESCRIPTION

Hate Speech

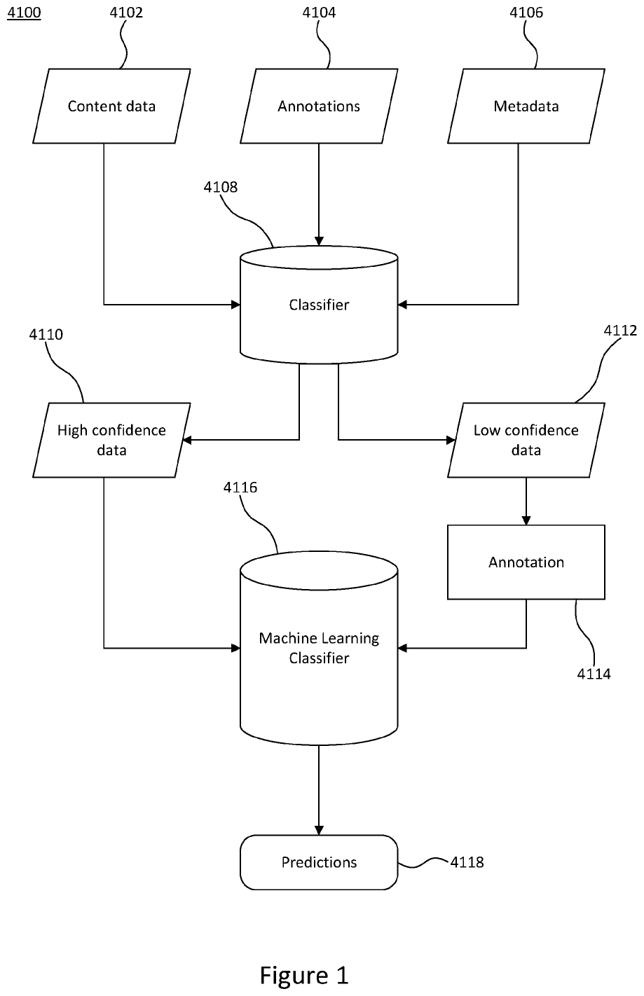

Referring to FIGS. 1, 2 and 3, example embodiments of a method of detecting contentious content will now be described.

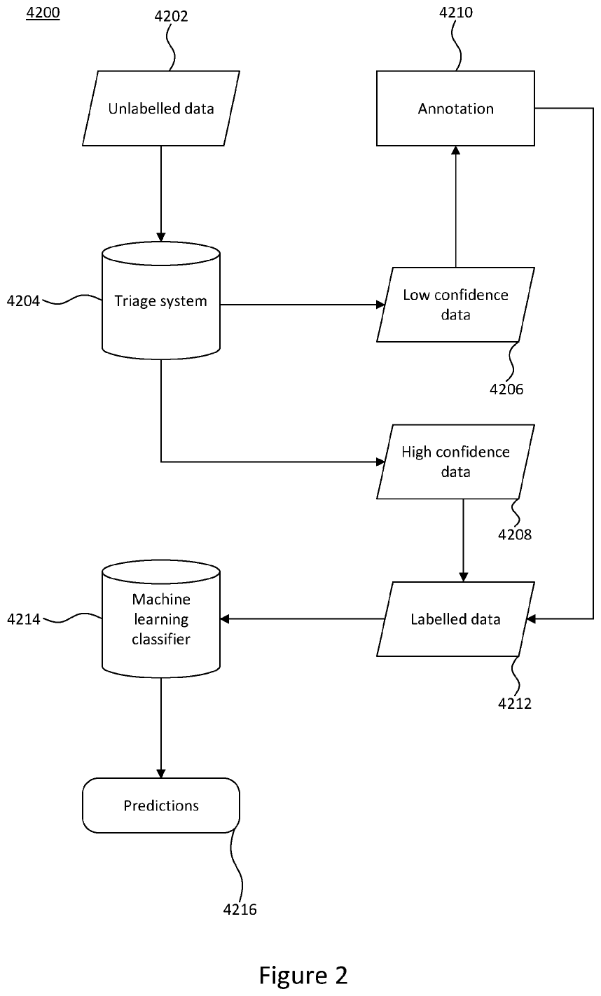

Referring to the FIGS. 1 and 2, example embodiments of training a machine learning classifier in order to detect contentious online content will now be described.

In an embodiment, the method of training a machine learning classifier, 4116 as shown in FIG. 1, initially starts with content data, 4102, which may or may not contain contentious content such as hate speech, cyber-bullying, cyber-threats, online-harassment and online-abuse etc. Each content data is generated within an online source which may be unlabelled data as shown in FIG. 2, 4202, and are input through a classifier 4108. An example of such a classifier may be a triage system as shown in FIG. 2 as 4204. Each content is assigned a probability representing the confidence of determining contentious content within the unlabelled content. The probabilities will be assigned depending on how many questions were asked before rejection. These probabilities then are used to determine whether the content is considered to have a high confidence of being contentious content, as shown as 4110 and 4206, or low confidence of being contentious content, as shown as 4112 and 4208.

In this embodiment, the detection method is implemented at a sentence level. When larger text is presented as input, e.g. whole articles, the article may be split into sentences and each sentence is scored for contentious content independently. The article may be then scored for contentious content as a whole.

In understanding contentious content, content may comprise of one or more domains such as hate speech, cyber-bullying, online-abuse etc. In the example of hate speech, this may be understood as sexist, racist or ethnic statements that, for example: use sexist, racist or ethnic slur; attack a minority; seeks to negatively distort views on a marginalised group/minority; negatively stereotypes a minority; and/or defends xenophobia or sexism. However, the view on the domain of hate speech may vary in time and the method as described here may be altered such that the classifier detects contentious content.

So, for example, the following utterances should be marked as hate speech:
“Except that there was no such sexual torture and she is a lying bitch”
“I told you all Muslims steal things”
“Niggers look dirty”
“I hate Asian cleaners”

And more complicated cases are as follows:
“I am not a sexist, but girls do not know mathematics and physics”
“There is no comparing the vileness of Mohammed to Jesus or Buddha, or Lao Tse”
“Women are delicate flowers and need to be protected”

In an embodiment, the triage system, 4204, may be designed to generate and ask a number of questions to each input content. Examples of such questions that may be asked may be as follows. Does the document contain a human or demographic entity? Is the document negatively sentimented? What is the stance towards the entity? Does the document bear high similarity to documents in highly toxic communities? These questions will be answered using Natural Language Processing tools like stance detection and sentiment analysis etc.

In an embodiment, there may be a weighting of the questions which are asked by the system. Optionally, the weighting may depend on the level of certainty of the system in answering the questions i.e. if it is known that for a particular question a response is correct only 70% of the time, a weight to that question might be applied such that its level of certainty is taken into consideration.

In an embodiment, the questions may either be set up such that all questions are asked at once and then the result of them are passed into a classifier. Optionally there may be a hierarchal order to the questions which are asked by the system. Should the system ask each question one at a time in turn, the initial questions will focus on those that have a high recall such that as many relevant documents as possible may be retrieved i.e. first general broad questions, narrowing down to more specific questions. Alternatively, higher weighted questions asked first and then follow with an appropriate set of underlying questions determined by the system. In training the machine learning classifier, the focus of generating the questions may target the precision level in determining contentious content, such that negative examples are mitigated and only those of contentious content are retained as labelled data.

In an embodiment, various approaches may be implemented. Implemented here is the approach of building methods for leveraging unlabelled data for automating the annotation process. Large annotated datasets may be created by leveraging the fact that there are known communities, for example on Twitter, Facebook, Voat, and Reddit, where a majority of the content is contentious. This information may be leveraged along with NLP techniques such as stance detection in order to determine user profiles, user histories, sentiment, word embeddings, dictionaries of slurs and contentious words, in order to estimate likelihood of a document being abusive. Such an approach may be implemented by computing how close a newly generated content is to a known abusive community.

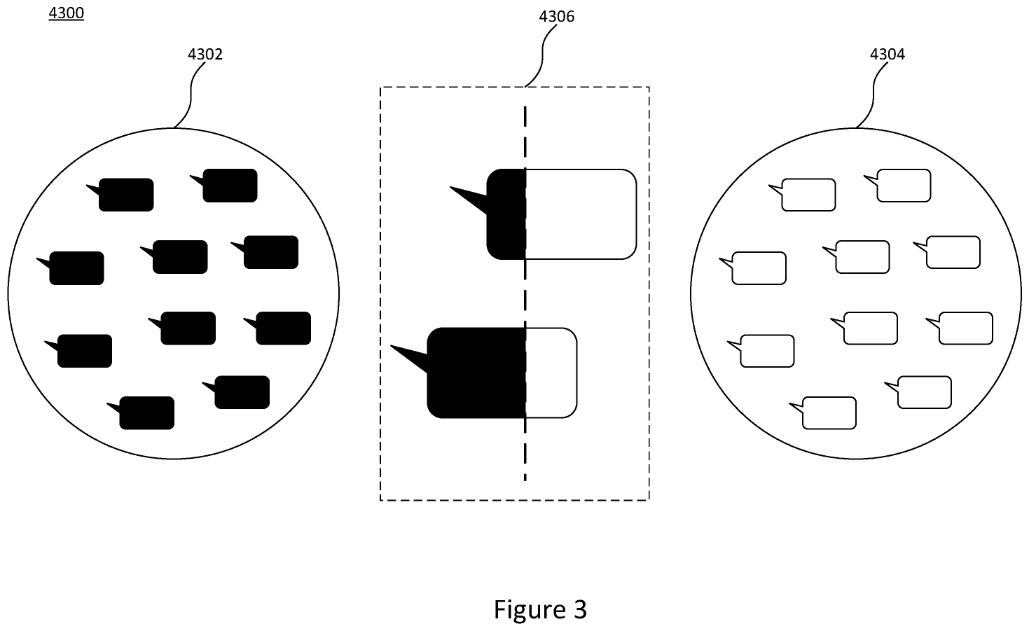

Also implemented is a bag of communities' approach as shown as 4300. FIG. 3 shows a conceptual representation of where, in this case, two source communities are employed as shown as 4302 and 4306. Once new and unlabelled content, such as posts or blogs, are generated in a community, similarity scores may be assigned to each content by means of comparison against pre-existing contents which have been generated within other communities as shown as 4304. A downstream classifier makes use of the similarity scores in order to make predictions regarding contentious content.

In this embodiment, the bag of communities' approach, 4300, is used to filter content which are unlikely to be seen as contentious content in combination with methods such as sentiment analysis, target detection and stance detection etc. The aim of this system is specifically to minimise the load on annotators and be able to prepare any given annotator that there's a likelihood that they will be facing abusive comments for annotation.

In an embodiment, the content for which result in a low confidence, 4112 and 4206, such that the content is not seen to contain contentious content, or not high enough confidence, will be assigned probabilities and assigned to annotators for review as shown as 4114 and 4210. The probability will be assigned depending on how many questions were asked before rejection.

In an embodiment, there may be an approach in content annotation such as an intersectional feminist approach. This specifically means try to attack the problem of how a vast body of literature may be applied from the social sciences on hate speech, bullying, etc. and incorporate them into computational methods. In practice, this may be done via author profiling and data set annotation. For example, by getting annotators who are female and feminists to help label articles which they find hateful towards female feminists, and make it clear in the profile of the annotator building the dataset that they are in fact female and feminists. Building an annotation platform may comprise of setting up a full annotation pipeline and product/tool which enable users to self-classify the social faction from which they are part of, e.g. black, white, feminist, and then their annotations will be considered in this light. The annotator profiles may also comprise of qualifications, experiences, political stance etc. Using a web platform and/or browser extension, an annotation platform allows users to tag, score and/or label articles and share their descriptions and tags.

The contents for which has been determined high confidence of being contentious content, 4110 and 4208, at the end of the classifier, or the specific case of a triage system, are then added to labelled data that we already have and are used by the machine learning classifier, as shown as 4212, which looks at new unseen documents to predict whether they contain hate speech or not.

In an embodiment, the high-confidence contentious contents are added to a labelled dataset from which the model of the classifier may be trained further as shown as 4212. The classifier trained may also be functionable on urls which are tasked to check. When building a machine classifier model, labelled content will be checked against an evaluation/test set, which will be sampled from the datasets available at the time of training.

Within the machine learning classifier, 4116 and 4214, many machine learning models may be implemented, including but not limited to, a multi-task learning model, logistic regression, joint-learning, support vector machines etc. Depending on the model and the data which is used to train the model, the features used in modelling will change appropriately. In other embodiments there may require various different types of learning models in order to detect contentious content on multiple different types of data such as news or comments. The classifier may also include an ensemble of classifiers where the model is trained on the predictions of n models. Each model may potentially individually predict hate speech but not necessarily.

Referring to FIGS. 1 and 2, a method of using a trained classifier in detecting contentious content will be now described.

In an embodiment, various classifiers may be implemented as 4116 and 4214. One classifier may take into consideration domain adaptations, which may be any model which classifies for contentious content. This may be in the case of a single domain model and/or a multi domain model. For example, the classifier may detect sexist comments and another independently that can detect racist comments and a model that can detect both.

In this embodiment, various forms of abuse may share commonalities across 2 pairs of overlapping dimensions: Explicit/Implicit abuse and generalised/directed abuse. Various form of contentious content may be represented as different domains such as hate-speech and online abuse which are thus expressed within the said two pairs of dimensions. In addition to commonalities across distinct forms of hate speech such as racism, anti-semitism, and sexism, commonalities within written form are also leveraged upon. Such commonalities include whether there is a specific target of an utterance or it is aimed at a generalised other. Further, the model may also leverage commonalities that may arise along axis of explicit and implicit language for hate speech. In an embodiment, linguistic, geographic, political commonalities as well as commonalities in sentiment which may occur across different instances of hate speech may also be utilized.

In an embodiment, various models may take into consideration one or a combination of features and/or feature selection methods. These may comprise of, for example, transfer learning, clustering, dimensionality reduction, chi-squared test, joint learning, multi-task learning, generalising beyond informal text found on social media towards arbitrary websites, comments on articles, articles, blog posts etc. Other such methods for training a machine learning model on one data set and predicting on a different one which may have different distributions, topics, etc. may also be embedded into the classifier. Clustering documents may allow the checking whether a document exists in the cluster, if so then a feature may be activated in the models mentioned above.

Hyperpartisanship

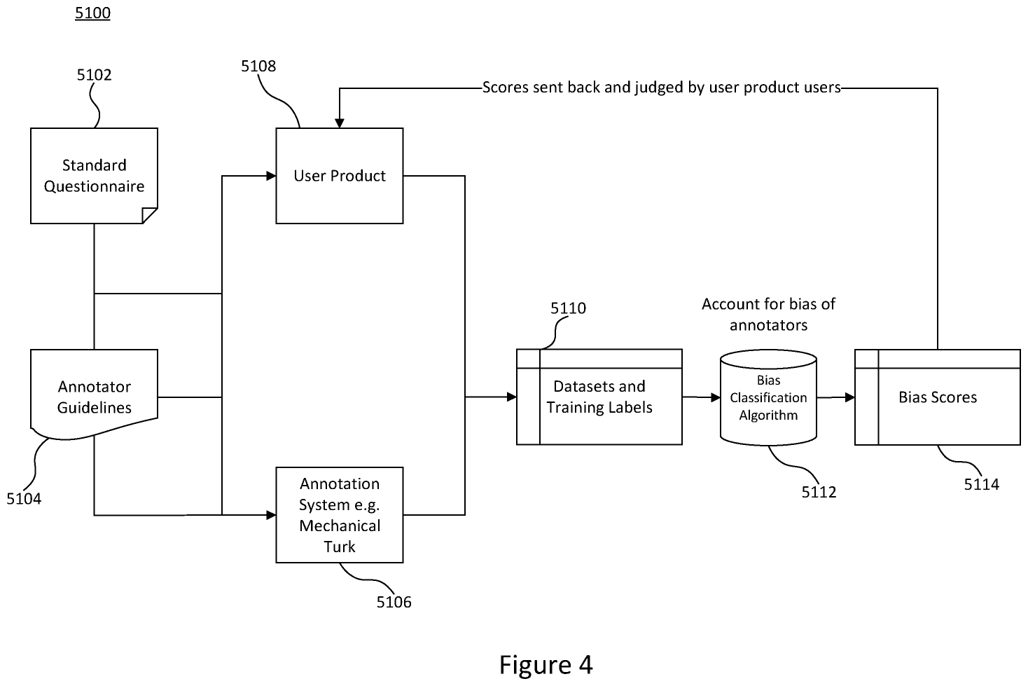

Referring to FIG. 4, example embodiments for a method of determining a bias score will now be described.

In an embodiment, there is provided a web-based method, system and algorithms which display and calculate the bias of a document as shown as 5100. The bias calculated may be displayed in various forms of scaled/grading score such as a score from 0 to 1 or a classification score indicating a score from extreme left to extreme right. These scores may be determined for both individual statements and full articles. The method of scoring bias may be based upon the bias expressed towards entities mentioned within content such as an article, however the method may be implemented similarly with other examples such as blogs and comments etc.

In an embodiment, reviewers may make use of a unique set of guidelines, as shown as 5104, built for the purpose of assisting the process of scoring the bias of content such as articles.

An example set of guidelines, which may include an overview of the form of bias the reviewer should look out for, a guideline as to the process of annotation as well as list of possible checkpoints the reviewer may investigate, are as follows:

Hyperpartisan news articles are extremely one-sided, extremely biased. These articles provide an unbalanced and provocative point of view in describing events.

1) Please spend 5-10 seconds evaluating the article. If you do not know if it is hyperpartisan or not, you should not spend much time on it. In which case, leave it be.
2) If you can say with confidence the url is hyperpartisan please click on Hyperion icon, and you'll be able to tag it as hyperpartisan news.
3) If you can say with confidence it is not hyperpartisan don't click on Hyperion icon for it. Quick “checkpoints”:
1. Topic of the article: news about politics could be hyperpartisan. News about sports, celebrities, fashion trends etc. are unlikely to be so.
2. Very loaded, emotive, offensive words, hyperbolic language (excepting headlines): “Trump has early-staged dementia”, ‘idiots’.
3. Capslock, exclamation marks: ‘SHOCK!!! Reporter Says He's Always Been A MASSIVE LIAR! This Is Terrifying!!!’
4. Imperatives, calls to action: ‘Add your name to millions demanding Congress pay attention to it! Impeach him’
5. Long (one paragraph or even more) pieces of texts contain subjective opinions (mostly at the end of the article), such as: ‘We can't think of a more appropriate network to break this news besides CNN. Trump has been attacking the network during his entire presidency, and the network hasn't taken the abuse lightly. Trump has made enemies with the press, and he is going down as more information comes to light’. Short subjective statements, like ‘anti-Trump’, also help to make conclusions about someone's political standing.
6. Many mentions about one definite person in text, with opposition towards him or with overly suggestive support: ‘President Trump's stock market rally is historical! No President has seen more all-time highs (63) in their first year in office than President Trump. President Trump set the record’.

In this embodiment, the set of guidelines may be of the form of an interactive checklist for the reviewer in order to notify the system which of the checkpoints have been referred to during the decision of a review score and/or labelling the content regarding the bias of information within the content.

In another embodiment, as a set of guidelines there may be provided four labels of four different features: leaded language; unsupported assertions; relies on opinion, not facts; overall bias feature. For example, an article may contain emotive language, caps lock and imperatives; contains lack of references for the provided statistics; contains subjective opinions; presents overly suggestive support or opposition towards this person or organisation. For each feature, a scaled/graded score may be determined regarding the hyperpartisanship of a piece of content.

In an embodiment, the individual and combined feature scores may be compared to a golden standard of hyperpartisanship annotations which may be manually or automatically determined. Reviewers whose scores correlate accordingly to the golden standard of annotations may be provided with access to annotate further content. The comparison between annotations and the golden standard may contribute to the weighting of a reviewer's review score in further annotations. For example, if a reviewer scores a particular piece of content unpartisan for which the golden standard is very partisan, the incorrect scoring may contribute to the weighting of the quality of further annotations provided by that particular reviewer.

In an embodiment, there may be provided a method whereby the annotation process general public users to score individual articles based on if they are clearly biased to one side or the other, using a browser extension to tag individual statements as well as the overall article as a whole. This is shown as 5108 in FIG. 4. The scores of each content such as an article may be used as a set of labels that can optimise a neural network model, which can be implemented to evaluate the bias of any content such a newly generated article in a substantially real-time. An article may contain various forms of statistics, images and videos, however, there are a lack of references towards these sources.

In this embodiment, the method in determining the bias of the content may take into account the political bias of the reviewer in coming up with a review score. For example, those who answer a standardised questionnaire, as shown as 5102, which may determine the reviewer as right-wing, but then score an article as right wing, will right-weight the bias score in comparison to a left-wing reviewer who scores the same article as right wing. The reviewing process may include a process of automatically and/or manually receiving user/reviewer profile information such as their political leanings, nationality, core expertise, experience, publications to which the user/reviewer subscribe to etc. Such profile information may contribute in determining the overall bias score of the content. The main component of classifying the bias of reviewers is carried out according to a credibility graph comprising the ratings of others relative to the reviewer. For example, if other reviewers determined a certain comment to be biased, they may label it as so, and the bias of the reviewer will also be crowd based.

In an embodiment, the method may take into account the political bias of annotators providing the scores. Using a user interface, annotators may be delivered samples from a standardised questionnaire consisting of contents where the bias of each of the content has been pre-determined manually, by experts or specialists, and/or automatically. Using the provided scores of the annotators, a bias position such as a political position may be determined for the annotators in a multidimensional array, for example. As a further example, if an annotator has been determined as having a right-winged bias and scores a piece of content as right-winged, the system may label the content weighted towards right-winged compared to the same annotation by a left-winged annotator.

In an embodiment, the process of providing a review score may comprise a threshold for reviewers in providing the review score and/or a judgment by the reviewer following a set of guidelines. Within an annotation system, as shown as 5106, there may be a tag which annotators are required to label pieces of content, for example “quite biased” or “neutral”. The annotation system may be repurposed for a specific use case which may be more specific as a workflow, for example a set of guidelines provided as an onboarding screen as part of the user interface which shows what action should be taken in certain circumstances such as identifying a potentially biased article.

In some embodiments, general users of a user product may also be classified as reviewers. However, in cases of need for much more complex repurposing for a specific more complex annotation e.g. a workflow which will make the general user tool be too complex but someone like a Mechanical Turk won't mind using, general users and specialised reviewers may become separate sources of bias labels.

In an embodiment, annotated labels, as shown as 5110, are fed into an article which may be constantly run by a neural network in order to evaluate and determine the bias of the content such as an article. The steps of evaluation and determination of content bias may be carried out by a bias classification algorithm as shown as 5112 in FIG. 4. The annotated labels of the classifier from the neural network may be reflective of tags, labels and/or descriptions provided by the users and/or reviewers. A set of labels may be embedded into an article by means of active learning. As an example, the neural networks assessment may output the article as a left-biased article whereas a right-biased user may determine the article to be a right-biased article. Such information may add to a training dataset which will add up over time as the model is constantly retrained in order to determine the bias of the article, as shown as 5114.

In an embodiment, crowd users may be aware of the bias score evaluated from the bias classification algorithm before and/or after labelling individual statements and/or full articles. User scores may accumulate to represent change in the bias score evaluated by the bias classification algorithm. Data may be presented to the user on the user interface as an initial baseline and instruction in order to provide context to the user.

In an embodiment, in the case where labels are provided in relation to both individual statements and full articles, there may be provided a step of determining the contribution of the individual statements taken into account when assessing the overall bias of the article within the bias classification algorithm by means of weighting the individual statements in relation to the full article. By means of example, if more than five statements are labelled as biased, the overall article is more biased compared to that if one statement is found to be biased. The algorithm used to determine the weighting of such contributions may comprise a deep learning model, or a Bayesian probabilistic model, or any other approach which aims to combine sentence level scores into an overall article score.

In an embodiment, the bias classification algorithm may take into consideration various automated scores such as scores indicative of: bias, content/user credibility, content/user stance. Bias may be seen as a vector of multiple variables, for example an article may support Donald Trump and also Hillary Clinton, or support Donald Trump and not support Mike Pence. The method may be scaled to multiple variables by use of learned models within the bias classification algorithm.

In an embodiment, the classification algorithm may take into account various variables as follows:
See the article bias score as a vector of the statements, claims and sentences in the article and their automated+annotated bias scores of the sentence.
See the article bias score as a vector of the annotator bias score of the article+automated method.
See the sentence bias score as a vector of the annotator bias score and the bias score of the sentence.
See the article bias score as a vector of the annotator bias score and the bias score of the sentence.

The example embodiments provide a method and system for scoring the political bias of any type of content. Such embodiments may overcome the existing problem relating to understanding difficulty of bias in content. For example, do users realise that all statements made target a certain entity or is against a particular entity? do users realise that a piece of content shows one viewpoint?

Example embodiments can provide solutions to existing problems such as: providing a consistent definition and methodology in identifying biased content; providing the ability to work on a larger scale in terms of annotating and classifying content through a semi-automated system; providing substantially real-time results which can be further optimised automatically or manually; providing embodiments which may be implemented on a variety of content such as sentences, pages, domains and publications; providing the ability to employ public annotators as well as specialist annotators; and considering annotator bias prior to content classification.

Credibility Score

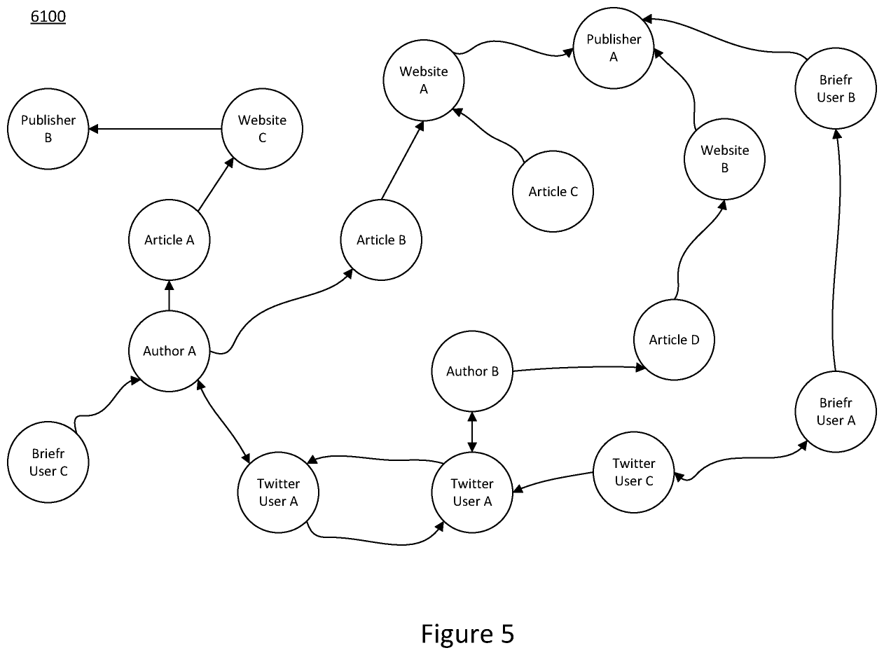

Referring to FIGS. 5, 6 and 7, example embodiments for a method of determining a score indicative of credibility of one or more users online will now be described.

In an embodiment, a method and system for assessing the quality of content generated by a user and their position within a credibility graph in order to generate a reliable credibility score is provided. The credibility score may be determined for a person, organisation, brand or piece of content by means of calculation using a combination of extrinsic signals, content signals, and its position within the credibility graph. The method may be further capable of determining a credibility score of the user of the generated content by the combination of the score indicative of the credibility of the content and the score indicative of the credibility of the user. Thus, a credibility score is built through a combination of data mining, automated scoring and endorsements by other credible agents as will be described herein.

In an embodiment, extrinsic signals may include metadata in relation to the one or more users comprising: gender; age; socio-economic status; socio-economic background; accreditations; financial interests; expertise; verification status; and/or other external user data.

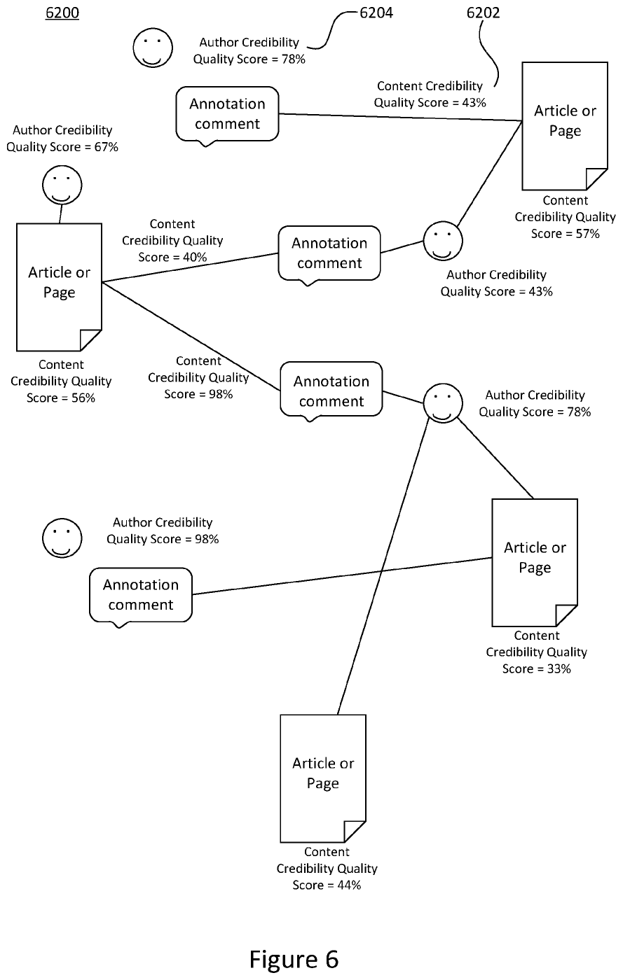

In this embodiment, user or author credibility, as shown as 6204 in FIG. 6, can be based on the examples as follows:
Author's expertise
Author is famous for independence and/or bravery
Author is followed by respectable people
Author is followed by someone deeply respectable
Credibility of the author
Financial interests of author
Platforms and key sources used by the author
Reputation of the author
Credentials of the author
The author or source is trusted by people I respect/trust
Verifiable author
Where the author is someone I trust to be conscientious, meticulous or has a good track record in terms of generated content.
Name of the author
A particular subject the author has written about
Errors or bias in content written by the author

Author and content credibility score based on endorsement network (‘credibility graph’), external credentials, and feedback on evaluation of online content.

In an embodiment, content signals may include one or more automated scores which are indicative of a number of factors such as: contentious content; content/user bias; content/user quality; content/user credibility; and/or true/false content. As form of content signal there may also include manual input of scores in relation to credibility which may be input by users of highly credible status.

In this embodiment, the credibility feedback, as shown as 6202 In FIG. 6, may be derived from an assessment of the quality of user generated content through neural networks and other algorithms detecting for example hate speech, hyper-partisanship or false claims, and other forms of quality and credibility scoring systems.

In an embodiment, the position of a user within a credibility graph may be determined by analysing and assessing data reflective of a user's credibility. FIG. 5, 6100, shows an example flow of user-user, content-user, and content-content interactions online. The user's position may be determined upon various factors such as: the user's professional affiliations; relationships the user has with other users and/or interactions with other users; the quality of content produced by the user; the quality of content which may be associated with the user; credibility of content produced by the user; credibility of other content associated with the user.

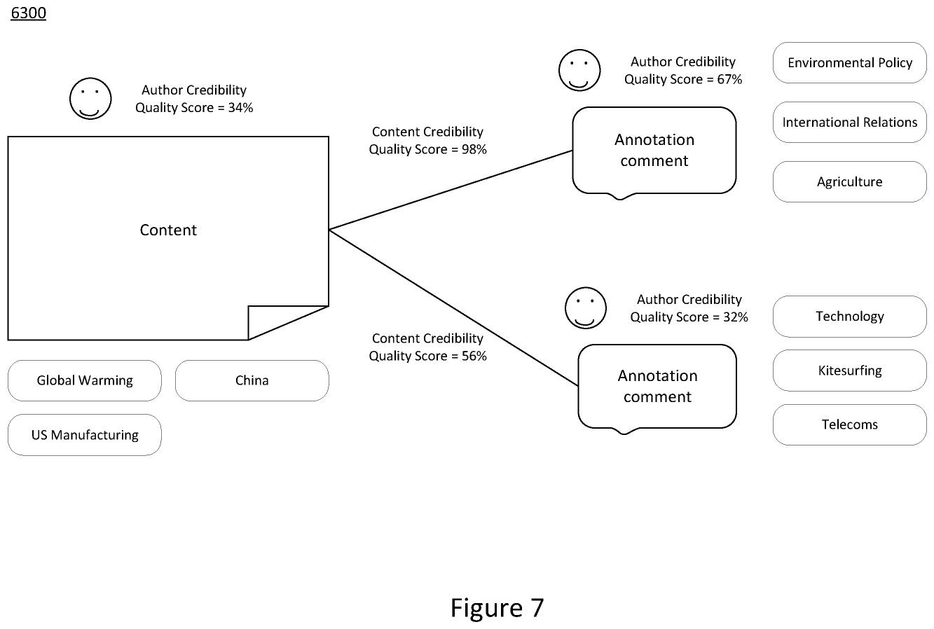

In other embodiments, additional factors can contribute to the overall credibility score of contents and users. One example, as shown as 6300 in FIG. 7, may be analysing the genre or the specific topic embedded within the content whether it may be explicitly stated or implicitly mentioned. In this example, the genre or topic within the content is compared against related content such as comments on a blog post for example. The comparison may indicate the level of relevance of the comment in relation to that blog post.

In some embodiment, bias assessment of content which may contribute to author credibility may be carried out methods of crowdsourcing bias assessments. For example, articles may be drawn from a pilot study, representing a corpus of example 1,000 articles on which ads had been displayed for the account of a customer; these thus form a sample of highly visited news articles from mainstream media as well as more partisan blog-like “news” sources. Platforms such as Crowdflower may be used to present these articles to participants who are asked to read each article's webpage and answer the question: “Overall, how biased is this article?”, providing one answer form the following bias scale, or any other bias scale: 1. Unbiased 2. Fairly unbiased 3. Somewhat biased 4. Biased 5. Extremely biased.

In order to guide crowdsourced assessments, contributors may be provided with more details regarding how to classify articles in the form of a general definition of biased article as well as examples of articles with their expected classification. An example instruction template may be provided as follows.

“Providing a definition as such: Biased articles provide an unbalanced point of view in describing events; they are either strongly opposed to or strongly in favour of a person, a party, a country . . . . Very often the bias is about politics (e.g. the article is strongly biased in favour of Republicans or Democrats), but it can be about other entities (e.g. anti-science bias, pro-Brexit bias, bias against a country, a religion . . . ). A biased article supports a particular position, political view, person or organization with overly suggestive support or opposition with disregard for accuracy, often omitting valid information that would run counter to its narrative. Often, extremely biased articles attempt to inflame emotion using loaded language and offensive words to target and belittle the people, institutions, or political affiliations it dislikes. Rules and Tips Rate the article on the “bias scale” following these instructions:
Provide a rating of 1 if the article is not biased at all; the article might discuss cooking, movies, lifestyle . . . or talk about politics in a neutral and factual way.
Provide a rating of 2 if the article is fairly unbiased; the article might talk about contentious topics, like politics, but remains fairly neutral.
Provide a rating of 3 if the article is somewhat biased or if it is impossible to determine its bias, or the article is ambivalent (i.e. biased both for and against the same entity).
Provide a rating of 4 if the article is clearly biased; it overtly favours or denigrates a side, typically an opinion piece with little fairness.
Provide a rating of 5 if the article is extremely biased/hyper partisan; it overtly favours a side in emphatic terms and/or belittles the other ‘side’, with disregard for accuracy, and attempts to incite an action or emotion in the reader.

Please do not include your own personal political opinion on the subject of the article or the website itself. If you agree with the bias of the article, you still should tag is as biased. Try and remove any sense of your personal political beliefs, and critically examine the language and the way the article has been written.

Please do not pay attention to other information on the webpage (page layout, other articles, advertising etc.). Only the content of the article is relevant here: text, hyperlinks in it, photos and videos within the text of the article. Also, do not look at the title of the website, its name, or how it looks—just examine the article in front of you and its text.

Do not answer randomly, submissions may be rejected if there is evidence that a worker is providing spam responses. Do not skip the rating, providing an overall bias is required.”

A suitable bias scale may be chosen to allow contributors to express their degree of certainty, for example leaving the central value on the scale (3) for when they are unsure about the article bias while the values 1 and 2 or 4 and 5 represent higher confidence that the article is respectively unbiased or biased to a more (1 and 5) or less (2 and 4) marked extent. Fifty participants contributed to the labelling and five to fifteen contributors assessed each article.

In an embodiment, to assess the reliability of contributors within a crowdsourced platform, one or more expert annotators (such as a journalist and a fact-checker) may be asked to estimate which bias ratings should be counted as acceptable for a number of articles within the dataset. For each article in this particular or ‘gold’ dataset, the values provided by the two experts are merged. Two values are typically found to be acceptable for an article (most often 1 and 2, or 4 and 5), but sometimes three values are deemed acceptable and less often one value only:

typically, when both experts agree the article is either clearly extremely biased or not biased at all (e.g. because it covers a trivial and non-confrontational topic in the latter case). When experts disagree on the nature of the bias, providing a set of acceptable ratings as strictly greater than three for one and strictly lower than three for the other, the article is not considered in the ‘gold’ dataset.

In one approach to guide one through assessing the quality of data collected through crowdsourcing, a comparison of contributors' rating may be carried out with the ‘gold’ dataset ratings in mind. Building on the “Beta reputation system” framework (Ismail and Josang 2002), users' reliability can be represented in the form of a beta probability density function. The beta distribution ƒ(p|α,β) can be expressed using the gamma function Γ as:

ƒ(p|α,β)=Γ(α+β)/(Γ(α)·Γ(β))·p^{α}(1−p))^{β-1}

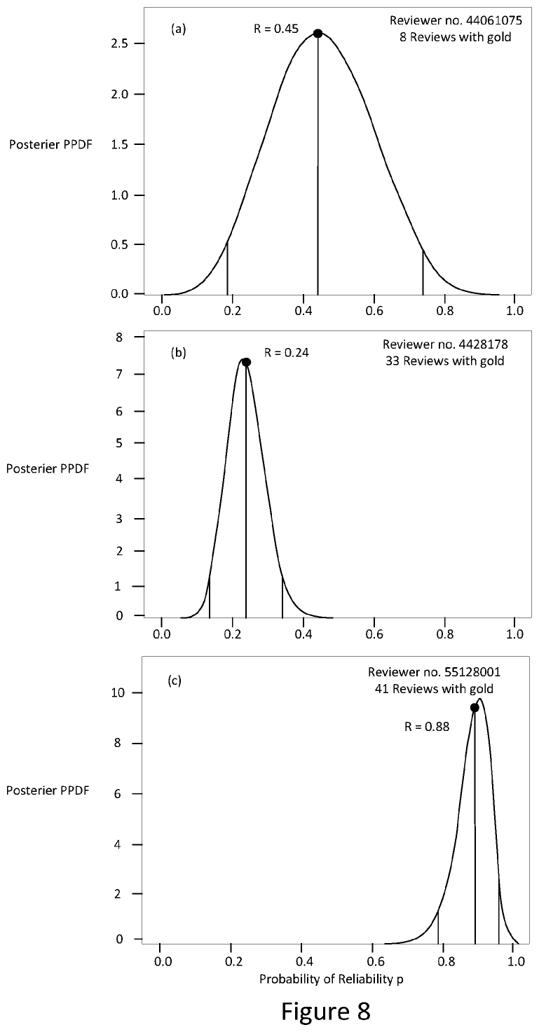

(1) where p is the probability a contributor will provide an acceptable rating, and α and β are the number of ‘correct’ (respectively ‘incorrect’) answers as compared to the gold. In order to account for the fact that not all incorrect answers are as far from the gold, the incorrect answers may be weighted as follows: an incorrect answer is weighted by a factor of 1, 2, 5 or 10 respectively if its shortest distance to an acceptable answer is 1, 2, 3 or 4 respectively. So β is incremented by 10 (resp. 2) for a contributor providing a rating of 1 (resp. 4) while the gold is 5 (resp. 2) for example. In embodiments, expectation values of the beta distribution R=α(α+β) may be used as a simple measure of the reliability of each contributor. FIG. 8 shows examples of reputation function obtained for (a) a user with few verified reviews, (b) a contributor of low reliability and (c) a user of high reliability.

In an embodiment, the goal may be to determine the articles' bias and a degree of confidence in that classification based on signals provided by the crowd. A straightforward way to obtain an overall rating is to simply take each assessment as a ‘vote’ and average these to obtain a single value for the article. However, to try and get closer to an objective assessment of the article's bias, an approach of weighting each rating by the reliability of the contributor may be tested. In some embodiments, a ‘linear’ weight for which a user's rating is weighted by its reliability R and a more aggressive ‘exponential’ weight for which a user's rating is weighted by 10^{4×(R-1/2)} so that an absolutely reliable (R=1) contributor's rating would weight a hundred times more than a contributor of reliability R=0.5.

Using a probabilistic framework allows for the estimation of the confidence of users' reliability scores. Weighting users' contributions by their reliability score increases the clarity of the data and allows for identification of the articles that have been confidently classified by the consensus of high reliability users to train one or more machine learning algorithms. In such cases, it may be notably so that high reliability contributors disagree on the bias rating for about a third of the articles, which may be used to train one or more machine learning models in order to recognize uncategorizable articles in addition to biased and unbiased.

In some embodiments, an important next step may be to learn about potential contributors' bias from the pattern of their article ratings: for instance a contributor might be systematically providing more “left-leaning” or “right-leaning” ratings than others, which could be taken into account as an additional way to generate objective classifications. Another avenue of research will be to mitigate possible bias in the gold dataset. This can be achieved by broadening the set of experts providing acceptable classification and/or by also calculating a reliability score for experts, who would start with a high prior reliability but have their reliability decrease if their ratings diverge from a classification by other users when a consensus emerges.

In an embodiment, the method of determining the credibility score of users may further generate a financial credit score for users more particularly based on the combination of user credibility and content credibility.

Explainability

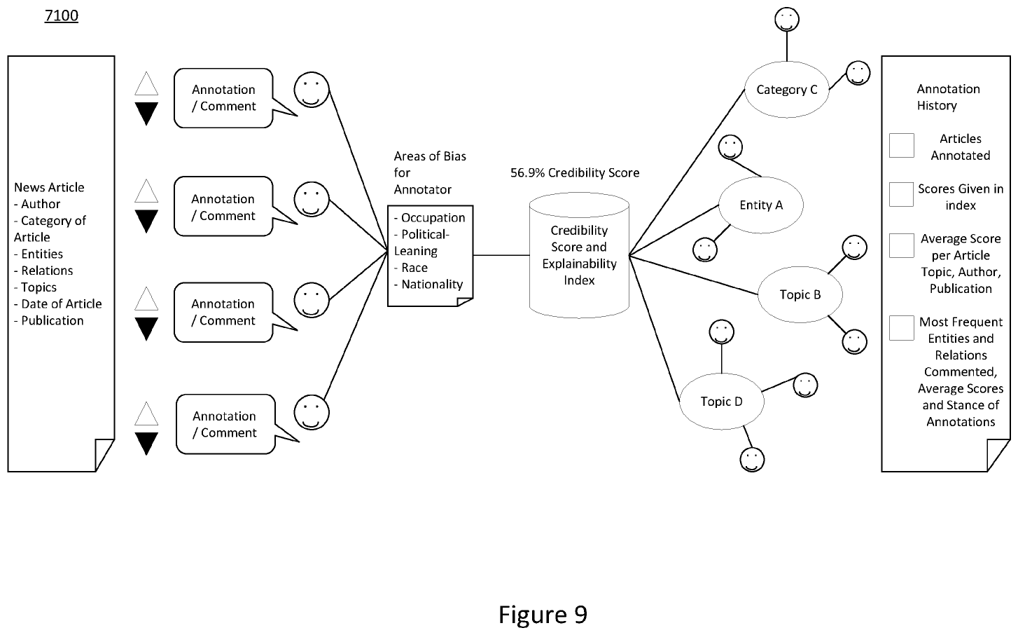

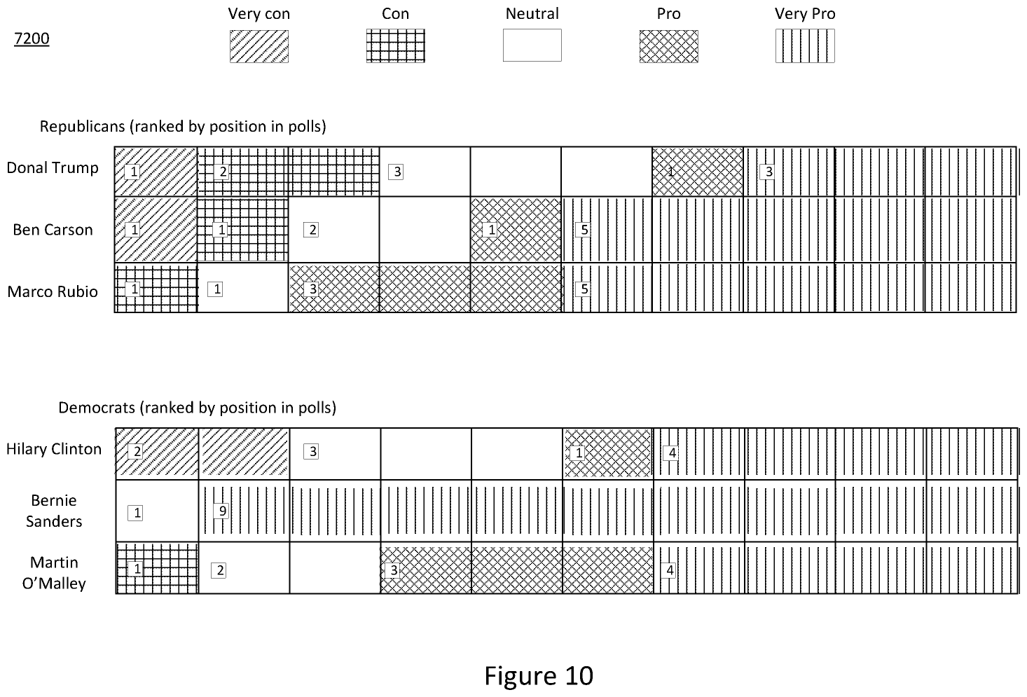

Referring to FIGS. 9 and 10, example embodiments for a method of storing data in relation to one or more annotations for enabling the visualisation and/or adjusting of the data will now be explained.

In an embodiment, a supervised natural language classifier may be present. Algorithms today encode bias into the way they are trained. In the case of a supervised natural language classifier which analyses text, several annotators may label an article for example as racist or right-leaning. However, if most of the annotators are coloured and/or left-leaning, algorithms which are set to classify the text as racist should take into account the bias of the available training data in weighting the output of the supervised learning algorithm. For example, any algorithm which may seek to reduce the weight of a label which was input for an article which is pro-Trump, by a pro-Trump supporter. Annotations, weights and bias scores are stored as data. This can be accomplished by means of pre-defined rules-based reweighting at the training stage of the learned representation of any algorithm, or a learned reweighting based on active learning or reinforcement learning. In the latter case, if a viewer of an algorithm output specifically labels the output of the algorithm as biased or unfairly classified based on the annotators providing the training data for the algorithm, the classification could be muted or reversed by automatically taking into account the training data which was used to train the algorithm in outputting that decision. In this sense, the learned representation or mapping may change based on such learned adjustments according to deep learning or deep learning techniques, from the reinforcement of viewer judgements towards algorithm outputs.

In an embodiment, there may also be a semi-supervised natural language classifier. In cases where annotations are not direct labels on a piece of content but rather indirect labels, such as comments on a blog post for example, the same reweighting process as undertaken by a supervised natural language classifier, or at least visibility into the training data is possible for a semi-supervised natural language classifier. A form of semi-supervised learning may be implemented such as online learning or active learning. Through active learning, annotators may provide judgements which directly impact and alter the result of a fully automated classifier. For example, for an algorithmically derived score of 8, an annotator may down weight the output score to 4. However, the reason for the annotator's action may be due to a source of bias on the part of the annotator. In such cases, one or more models may be implemented in order to allow for manual weighting of outputs which also take into consideration the bias with or without a provided explanation on the part of the annotator. Annotations, weights and bias scores are stored as data. Models may or may not require manual weighting of outputs based on pre-determined rules or heuristics based on accountability of factors such as race. There may also include automatic weighting based on learning of potential biases of annotators due to their annotator profiles, which may be a complex reweighting across a vector of factors such as gender, nationality and more.

In This embodiment, there is provided a reweighting aspect of the classifier algorithms such as logistic regression. Taking into consideration of user metadata and metadata in relation to one or more pieces of content, the classifier algorithm can be re-weighted according to one or more sets of hard coded and/or learnt rules and/or heuristics based around re-weighting. As for example, a coloured user annotating an article regarding white supremacy may be given more weight in their annotation scores. Re-weighting scores and bias scores are stored as data.

In an embodiment, the scores are input into a database which may be used as training data and may also be used as input into one or more classifiers or models.

In an embodiment, stored data may be input into a user interface enabling the visibility of training data. As shown as FIG. 10, an index is built where annotations are viewable within a graph database. In an embodiment, the interface may be interrogatable by a user and may provide a clear analysis into the bias of an annotator with regards a certain entity or topic. In this way, algorithmic explainability can focus on how a set of annotation data is built up.

In this embodiment, personal information such as names, addresses or numbers are not to be made visible. In this way, although the annotator is not personally identifiable, the data may show indicators of the bias of the author of the annotation.

Bias Detection

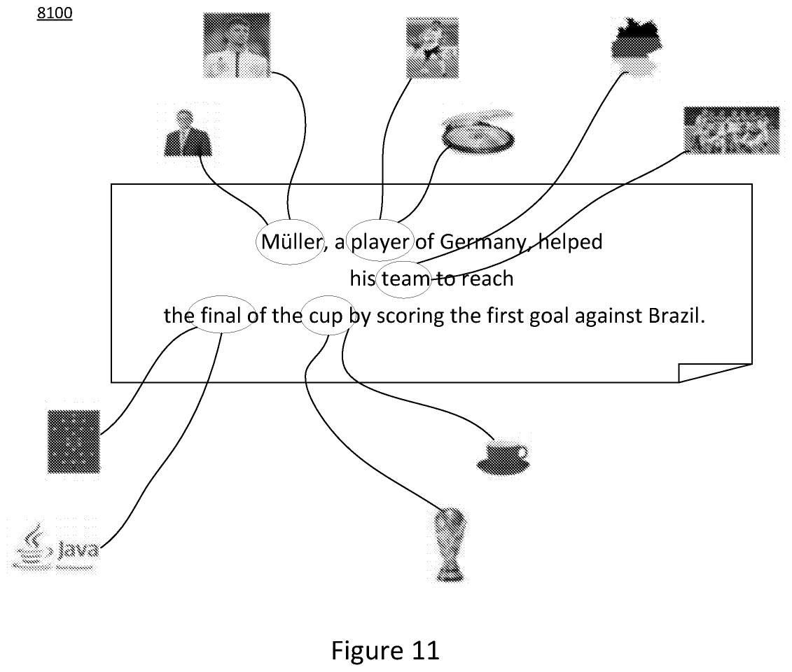

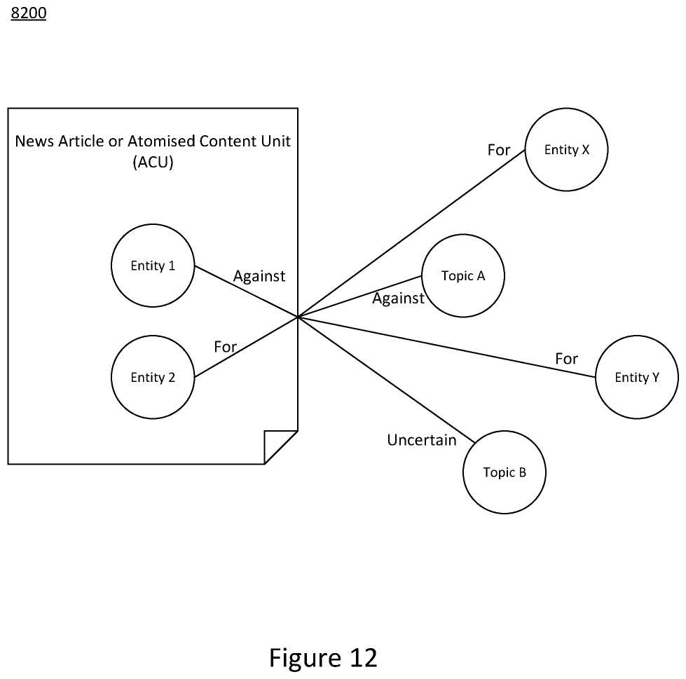

Referring to FIGS. 11 and 12, example embodiments for a method of determining a score indicative of stance in relation to content will now be described.

Stance detection is an important component of determining bias and fake news. Stance detection studies are for the most part applied to text within online debates wherein the stance of the text owner towards a particular target or entity is explored.

In an embodiment, the method of determining a score indicative of stance seeks to use machine learning and natural language processing, in particular stance detection, in order to build graphical representations and the stance of content towards explicitly/implicitly mentioned entities. Examples of such content assessed for its stance include any online generated content for example news articles, comments and blog posts etc.

In an embodiment, entities within a piece of content are assessed as shown in FIG. 11. In determining the one or more entities within a piece of content, entities directly associated with the text embedded within the content are analysed. For example, entities may include any of the following: one or more persons; one or more places; one or more objects; one or more institutions; one or more brands; one or more businesses; one or more countries; and/or one or more organisations. The step of determining the correctly implied entity within a given context of the content is dependent on natural language processing tasks which is implemented to: identify entity relating text; determine potential entity candidates which correlate with the text; and determine the entity through contextual analysis.

In an embodiment, a combination of natural language processing tasks and a classifier for a learned model based on stance detection may be implemented. Natural language processing tasks may include any of: entity linking; text understanding; automatic summarization; semantic search; machine translation; name ambiguity; word polysemy; and/or context dependencies. The learned model may include any other method such as bidirectional conditional encoding which can be performed in conjunction with stance detection.

In stance detection, the main objective is to determine the stance of the text owner, for example in favour, against, or neither, in relation to a particular target either explicitly or implicitly mentioned within the text. In an embodiment, the stance of user generated content may contribute to the user generating the content. This may form part of the user's profile which adds to the metadata of the user.

In some embodiments, in cases where there are one than one authors who have contributed to a piece of content, the author's stance may be determined by the stance of their individual contributions to the content. This may be the case for comments on a blog post for example.

In other cases, where for example an article was written by a number of authoring contributors, the overall stance of the article may contribute to the stance of the individual contributors.

In some cases, the target may not explicitly be mentioned in the content. For example, the tweet “@realDonaldTrump is the only honest voice of the @GOP” expresses a positive stance towards the target Donald Trump. However, when stance is annotated with respect to Hillary Clinton as the implicit target, this tweet expresses a negative stance. This may prove to be the case due to the fact that supporting candidates from one party implies negative stance towards candidates from other parties. In such cases, a model must be learned such that it interprets the stance towards a target that might not be mentioned within the content itself. On top of which, the model must be trained without the input of labelled training data for the target with respect to which the stance is predicted for. This is shown as FIG. 12 in the diagrams. As for the example above, a model must be learned for Hillary Clinton by only using training data for other targets, in this case Donald Trump.

In an embodiment, models are learned to determine one or more entities which correlate to the text within the content by means of determining commonalities between entities explicitly and implicitly mentioned as well as entities not mentioned within the content at all. In assessing implied and implicit language within a piece of content, in relation to the entities within that content, various natural language processing tasks may be implemented as well as knowledge graph embeddings. Knowledge graph embeddings project symbolic entities and relationships into a continuous vector space in order to find links between different entities. In an embodiment, the method may provide a stance towards a content with respect to a plurality of entities.

In an embodiment, one or more entities may be searched within a user interface or a search engine which may form part of a web platform or a browser extension. The entities are searched using representational vectors and/or knowledge graph embeddings in order to output a score indicative of stance corresponding to each of the input entities. The output may also consist of a visualisation of the entities and their linkages wherein the entities are linked by measure of stance towards the entities. The scores may further be cached and stored into a database which may be used as training data. In this way a graphical representation of stance towards entities may be built.

Annotation Platform

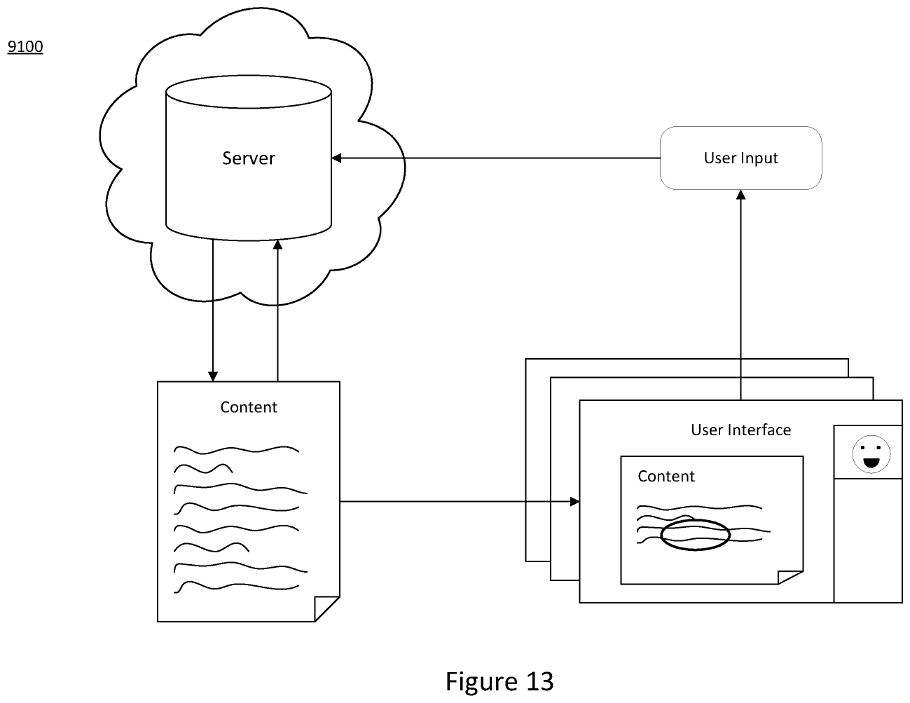

Referring to FIG. 13, example embodiments for a method of determining one or more content scores for one or more pieces of content will now be described.

In an embodiment, content generated online may be input into a processing server within a cloud, as shown as 9102 in FIG. 13. Within the processing server, content may be analysed to output partially or fully automated scores in relation to the content, as shown as 9104, and may also determine labels and/or tags in relation to the determined scores. For example, a score may indicate the bias within a content and/or truthfulness of a piece of content.

In an embodiment, a user interface may be present wherein enabling visibility of labels and/or tags, which may be determined automatically or by means of manual input, to a user or a plurality of users. This is shown as 9106 in FIG. 13. The user interface may form part of a web platform and/or a browser extension which provides users with the ability to manually label, tag and/or add description to content such as individual statements of an article and full articles, as shown as in 9106.

In an embodiment, users may provide indirect annotations for content whereby the annotation serves not as direct labelled data for a sentence, comment, page or paragraph classifiers, but as indirectly labelled data. For example, through a comment such as “This article is fascinating” the annotation can be used as an indirect signal which notifies an algorithm that the content may be more interesting than other content or may have a higher content score in comparison to other content,

In an embodiment, the inputs provided by users through a user interface is used as a further input towards assessing an appropriate and genuine score indicative of the user inputs. The user inputs, as shown as 9108 in FIG. 13, are stored as data within the processing server and may further be implemented as training data towards the continuous modelling of the processing server. The data is input into a learned model for the algorithmic analysis of the user inputs. Learned models and algorithms may be any of which take into consideration the contribution of user bias, content bias, user credibility, content credibility, user quality, content quality and metadata in relation to the content in question as well as metadata in relation each of the user inputs. Such data may be pre-determined or determined through manual and/or automatic scoring of content and users, assessing user histories, assessing user interactions and/or analysing user profiles.

In an embodiment, the learned models and algorithms handling the input data may also take into consideration metadata in relation to the author of the content. This may include author bias, author credibility, author quality and extrinsic data in relation to the author. In this embodiment, the learned models and algorithms within the processing server 9102 may take into account the contribution of a combination of the following: author's expertise; author is famous for independence and/or bravery; author is followed by respectable people; author is followed by someone deeply respectable; credibility of the author; platforms and key sources used by the author; reputation of the author; credentials of the author; the author or source is trusted by people I respect/trust; author is verifiable; author is trusted to be conscientious, meticulous or has a good track record in terms of generated content; a particular subject the author has written about; and/or errors or bias in content written by the author.

In an embodiment, the learned models and algorithms may also take into consideration metadata in relation to the information of the content. This may include content bias, content contentiousness, content credibility, content trustworthiness, links and/or references contained within content; links and/or references of the content in other contents; source of the content, topic and genre of the content, errors within the content, and other content signals.

In an embodiment, content signals may include one or more automated scores which are indicative of a number of factors such as: contentious content; content/user bias; content/user quality; content/user credibility; and/or true/false content. As form of content signal there may also include manual input of scores in relation to credibility which may be input by users of highly credible status. Content signals may be derived from an assessment of the quality of user generated content through neural networks and other algorithms detecting for example hate speech, hyper-partisanship or false claims, and other forms of quality and credibility scoring systems.

Q-CPM

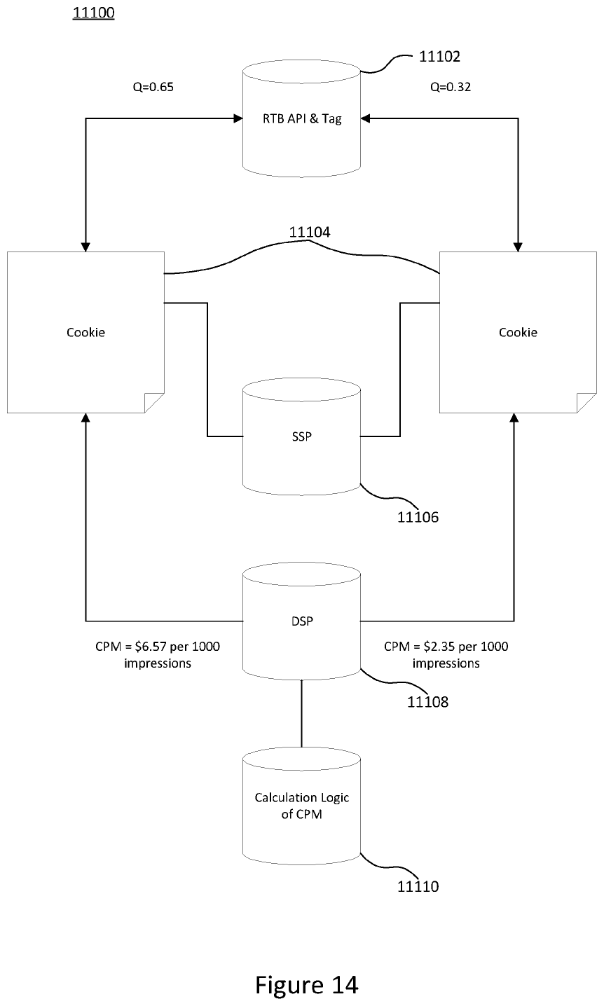

Referring to FIG. 14, example embodiments for a method of determining a cost of advertising on content will now be described.

In an embodiment, CPM or the cost of advertisement on online generated content may depend on numerous factors which include metadata of content. Producing a price for advertising is further based on the inherent quality or quality score of a piece of content such as an article. On top of quality scores directed towards domains, this embodiment focuses further on the inherent natural language and the semantic understanding of a piece of content. Content may be analysed within a cache in real time and/or offline in order to determine its quality.

In this embodiment, factors which contribute in assessing the quality of content and determining a cost of advertising on content may be input into a calculation logic, as shown as 11110 in FIG. 14. Factors in calculation may include: subject area; indication of originality; correction/redaction; content awards; genre; factual assertations; publications on the site; datelines on the site; headlines; authors; length of content; language of content; translation of content; source language; the article locator; datelines of location; translation of content; source language; subheadings; the publication domain registration date; the publication domain registration location; article rights; image/video geotags; author biographies; track records; accessibility of content; followers and/or listeners of the content; occupation of author; author's education credentials; number of publications made by the author; assessment of logical fallacy; assessment of false and/or misleading assertions; assessment of data presented by the content; verdicts from fact checking websites; links from other sites; content sharing on social media; social media engagement of content; ratio of endorsement variables such as comments and likes; social media links; social media comments; social media endorsements; number of links in Wikipedia; representation of scientific literatures; representation of scientific processes; perspectives taken into account within content; citation of wire services; identifiable victim effects; world fallacy; false representation of dilemmas; calibration of confidence within content; creating noise for signal; orders of understanding; content which draws around conclusions from available evidence; confirmation of bias; straw man arguments; slippery slope arguments; naturalistic fallacy; number of number of Enthymemes i.e. arguments with missing premises; number of argument components; number of claims; number of arguments against; number of supporting premises; the use of conspiratorial thinking; “begging the question”; average number of arguments for; number of attacking premises; quotes from external experts; content containing original quotes; content which misrepresents source articles; content which contain image macros; links to scientific journals; quotes of reputable scientists; databases; agencies of authority; number of links; number of quoted sources; original images; attributed images; video embeds; phone numbers; content part of press corporations; niche topics; noted awards; trust project metadata; clear editorial policies; mastheads (nameplate); publication end date; publication start date; publication type; publication identifier; publication owner; publication name; publication CMS; publication domain; mastheads (imprint); site analytics; average time spent on content; common referrers; volume of readership with respect to time; emotion of comments shared; presence of advertisements; presence of donors; presence of paywall; presence of subscriptions; presence of sponsors; presence of premium content; presence of Freemium content; top call to action for donations; clickbait headlines; content which contain profanity; content which contain hyperbolic language; content which contain hyper partisanship/political bias; politicising tones present; grammar of content; astroturfing; overly emotional language present in content; exaggeration tones; indication of contentious content; cognitive distortions; number of exclamation points; and/or apophasis within content.

In an embodiment, platforms may also take into consideration cookie IDs of users, as shown as 11104 in FIG. 14, as well as taking into account URLs users are interacting with actively or passively. These factors may also be input to the calculation logic as shown as 11110. On top of which, the notion of quality score may be applied to a real-time bidding environment for advertisement of content. In this embodiment, a network of pricing for advertisements may contribute to the bidding of impressions within content.

In an embodiment, brands may benefit from advertisements appearing next to higher quality inventory, by which the way their brand is represented next to such content. The addition of quality imbedded in determining the overall CPM may incentivise brands to create higher quality advertisement content and as well as authors, publishers and site owners to create general higher quality content in order to increase buyers and user engagement. In order to create a fair platform for advertisers and content publishers, a pre-determined floor price can be input into the calculation logic 11110.

Any system feature as described herein may also be provided as a method feature, and vice versa. As used herein, means plus function features may be expressed alternatively in terms of their corresponding structure.

Any feature in one aspect may be applied to other aspects, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects can be implemented and/or supplied and/or used independently.

1.-88. (canceled)

89. A method comprising:
receiving an input content item, the input content item including a set of words;
generating, using natural language processing, a set of answers to a set of content questions based on the set of words included in the input content item, the set of answers indicating sentiment of the input content item;
determining, based on the set of answers, a confidence score indicating a confidence level that the input content items includes contentions content;
comparing the confidence score to a threshold confidence score; and
in response to determining that the confidence score meets or exceeds the threshold confidence score, labeling the input content item as contentions content, yielding a labeled content item.

90. The method of claim 89, further comprising:
receiving a second input content item including a second set of words;
generating, using natural language processing, a second set of answers to the set of content questions based on the second set of words included in the second input content item, the second set of answers indicating sentiment of the second input content item;
determining, based on the second set of answers, a second confidence score indicating a confidence level that the second input content items includes contentions content;
comparing the second confidence score to the threshold confidence score; and
in response to determining that the second confidence score is less than the threshold confidence score, assigning the second input content item to an annotator for review.

91. The method of claim 90, further comprising:
receiving, from the annotator, data indicating that the second input content item does not include contentious content; and
labeling the second input content item as not being contentions content, yielding a second labeled content item.

92. The method of claim 91, further comprising:
training a machine learning classifier to detect contentions content based on a set of labeled training data, the set of labeled training data including at least the first labeled content item and the second labeled content item.

93. The method of claim 90, further comprising:
receiving, from the annotator, data indicating that the second input content item includes contentious content; and
labeling the second input content item as being contentions content, yielding a second labeled content item.

94. The method of claim 89, wherein generating the set of answers to the set of content questions comprises processing the set of content questions according to a hierarchical order assigned to the set of content questions.

95. The method of claim 89, wherein determining the confidence score comprises:
assigning a first weight to a first answer from the set of answers, yielding a first weighted answer;
assigning a second weight to a second answer from the set of answers, yielding a second weighted answer, wherein the first weight is different than the second weight; and
determining the confidence score based on the first weighted answer and the second weighed answer.

96. The method of claim 89, further comprising:
determining, based on the confidence score for the input content item, monetary values to be charged for presenting sponsored content along with the first content item.

97. The method of claim 96, wherein determining the monetary value comprises:
determining, based on a first cookie identifier (ID) associated with a first user and the confidence score, a first monetary value for presenting a first sponsored content item to the first user along with the first content item; and
determining, based on a second cookie ID associated with a second user and the confidence score, a second monetary value for presenting a second sponsored content item to the first user along with the first content item, wherein the first monetary value is different than the second monetary value.

98. The method of claim 96, wherein determining the monetary value comprises:
determining, based on a first set of Uniform Resource Locators (URLs) associated with a first user and the confidence score, a first monetary value for presenting a first sponsored content item to the first user along with the first content item; and
determining, based on a second set of URLs associated with a second user and the confidence score, a second monetary value for presenting a second sponsored content item to the first user along with the first content item, wherein the first monetary value is different than the second monetary value.

99. A system comprising:
one or more computer processors; and
one or more computer-readable mediums storing instructions that, when executed by the one or more computer processors, cause the system to perform operations comprising:
receiving an input content item, the input content item including a set of words;
generating, using natural language processing, a set of answers to a set of content questions based on the set of words included in the input content item, the set of answers indicating sentiment of the input content item;
determining, based on the set of answers, a confidence score indicating a confidence level that the input content items includes contentions content;
comparing the confidence score to a threshold confidence score; and
in response to determining that the confidence score meets or exceeds the threshold confidence score, labeling the input content item as contentions content, yielding a labeled content item.

100. The system of claim 99, the operations further comprising:
receiving a second input content item including a second set of words;
generating, using natural language processing, a second set of answers to the set of content questions based on the second set of words included in the second input content item, the second set of answers indicating sentiment of the second input content item;
determining, based on the second set of answers, a second confidence score indicating a confidence level that the second input content items includes contentions content;
comparing the second confidence score to the threshold confidence score; and
in response to determining that the second confidence score is less than the threshold confidence score, assigning the second input content item to an annotator for review.

101. The system of claim 100, the operations further comprising:
receiving, from the annotator, data indicating that the second input content item does not include contentious content; and
labeling the second input content item as not being contentions content, yielding a second labeled content item.

102. The system of claim 101, the operations further comprising:
training a machine learning classifier to detect contentions content based on a set of labeled training data, the set of labeled training data including at least the first labeled content item and the second labeled content item.

103. The system of claim 100, the operations further comprising:
receiving, from the annotator, data indicating that the second input content item includes contentious content; and
labeling the second input content item as being contentions content, yielding a second labeled content item.

104. The system of claim 99, wherein generating the set of answers to the set of content questions comprises processing the set of content questions according to a hierarchical order assigned to the set of content questions.

105. The system of claim 99, wherein determining the confidence score comprises:
assigning a first weight to a first answer from the set of answers, yielding a first weighted answer;
assigning a second weight to a second answer from the set of answers, yielding a second weighted answer, wherein the first weight is different than the second weight; and
determining the confidence score based on the first weighted answer and the second weighed answer.

106. The system of claim 99, the operations further comprising:
determining, based on the confidence score for the input content item, monetary values to be charged for presenting sponsored content along with the first content item.

107. The system of claim 106, wherein determining the monetary value comprises:
determining, based on a first cookie identifier (ID) associated with a first user and the confidence score, a first monetary value for presenting a first sponsored content item to the first user along with the first content item; and
determining, based on a second cookie ID associated with a second user and the confidence score, a second monetary value for presenting a second sponsored content item to the first user along with the first content item, wherein the first monetary value is different than the second monetary value.

108. A non-transitory computer-readable medium storing instructions that, when executed by one or more computer processors of one or more computing devices, cause the one or more computing devices to perform operations comprising:
receiving an input content item, the input content item including a set of words;
generating, using natural language processing, a set of answers to a set of content questions based on the set of words included in the input content item, the set of answers indicating sentiment of the input content item;
determining, based on the set of answers, a confidence score indicating a confidence level that the input content items includes contentions content;
comparing the confidence score to a threshold confidence score; and
in response to determining that the confidence score meets or exceeds the threshold confidence score, labeling the input content item as contentions content, yielding a labeled content item.
